(19) United States
(12) Patent Application Publication
(10) Pub. No.: US 2024/0090526 A1
(43) Pub. Date: Mar. 21, 2024

(54) PROCESS FOR THE PRODUCTION OF PLANT-BASED CRUMB

(71) Applicant: TIGER & BEAN S.L.U., Valencia (ES)

(72) Inventors: Robert BRUNT, Valencia (ES); Graham GODFREY, Worcestershire (GB)

(21) Appl. No.: 18/263,147

(22) PCT Filed: Jan. 28, 2022
(86) PCT No.: PCT/EP2022/052115

§ 371 Date: Jul. 27, 2023

(30) Foreign Application Priority Data
Jan. 29, 2021 (EP) 21382076.4

(51) Int. Cl. A23G 1/48; A23G 1/56

(52) U.S. Cl. CPC A23G 1/48; A23G 1/56

(57) ABSTRACT

The present invention relates to processes and ingredient formulations for the preparation of a plant-based chocolate crumb, preferably a dairy-free or vegan crumb, more preferably an allergen-free vegan crumb, for use in the production of confectionery, such as dairy-free alternatives to milk chocolate and white chocolate. The present invention also relates to uses of the plant-based crumb described herein, for example in the production of plant-based (i.e. dairy-free or vegan) chocolate and chocolate products, and to plant-based chocolates and chocolate products produced using the processes and ingredients described herein. A process of the invention comprises the steps of: liquefaction and/or saccharification; and crumb formation, wherein the plant-based milk is heated and dried to a crumb.

### FIELD OF THE INVENTION

The present invention relates to processes and ingredient formulations for the preparation of a plant-based crumb, preferably a dairy-free or vegan crumb, for use in the production of confectionery, such as dairy-free alternatives to milk chocolate and white chocolate. The present invention also relates to uses of the plant-based crumb described herein, for example in the production of plant-based (i.e. dairy-free or vegan) chocolate and chocolate products, and to plant-based chocolates and chocolate products produced using the processes and ingredients described herein.

### BACKGROUND

Milk chocolate and white chocolate are popular the world over.

A widely used method for producing white chocolate is to mix vegetable fats such as cocoa butter with dry ingredients such as sugar and powdered (dehydrated e.g. by spray drying) milk products, followed by a process of refining, conching and tempering where necessary. Milk chocolate is commonly prepared by including cocoa solids, in the form of cocoa liquor, cocoa nibs or cocoa powder in the mixture of dry ingredients.

An alternative and advantageous method for producing milk chocolate and white chocolate, first developed in the 1870s by Daniel Peter, is “the crumb process”. In the crumb process, liquid milk or liquid milk-derived products (such as fresh milk, evaporated milk or reconstituted milk obtained by rehydrating powdered milk) are mixed together with sugar for the production of white crumb, and together with sugar and cocoa liquor, cocoa nibs or cocoa powder for the production of milk chocolate crumb. The liquid mixture is then concentrated (through the removal of water by means of evaporation) and co-dried, to obtain a dry, shelf stable, crystallized mixture with a total final moisture content of between 1-3%. This is referred to in the art as “crumb” or “chocolate crumb” due to its appearance, which resembles breadcrumbs.

Traditional milk chocolate crumb and white chocolate crumb, typically contain between 7-10% milk fat, and 8-11% milk fat, respectively. Excessive milk fat in the crumb can have a softening effect on the final chocolate product. The total sugar content for traditional milk chocolate crumb and white chocolate crumb, is typically between 67-74% by weight, of which approximately 80% is typically sucrose. Sucrose is a non-reducing disaccharide and is generally required for crystallization and stability of the final confectionery product.

Thereafter, white chocolate or milk chocolate is typically obtained by simply mixing the white crumb or milk chocolate crumb with the remaining ingredients, namely vegetable fats such as cocoa butter and emulsifiers. The mixture is then refined to reduce particle size and conched to produce a liquid chocolate, which thereafter, and where necessary, is generally then tempered before forming finished products. The milk chocolate crumb and white crumb may comprise typically anything up to 80% weight percent (wt %) of the total ingredients of the final chocolate, making subsequent processing quick and simple.

A benefit of producing chocolate using a crumb process, involving the co-drying of milk and milk-derived ingredients in a hydrous, liquid (wet) state with cocoa solid and/or sugar, is that by carefully controlling the composition, temperature, moisture content, pH and the duration of drying, amongst other parameters, chocolate manufacturers can tailor the flavours of a chocolate. Chocolate with a complex range of flavour volatiles and superior taste can be obtained by optimising enhanced Maillard reactions that occur as a result of the condensation of reducing milk sugars (i.e. lactose) with free proteins e.g. those found in milk (mainly the lysine residues of casein) and (where present) the peptides in the cocoa solids. Chocolate made using conventionally dehydrated e.g. spray-dried milk lacks the distinctive and complex browning flavours that are typical of crumb-based chocolate. The process of spray drying is rapid by design: it atomizes liquids into small free-falling droplets and exposes them to hot gas within the drying chamber so that the liquid dries in a matter of seconds. The rapidity of spray drying deliberately minimise any changes to the flavour of the product. In particular a rapid drying process prevents or minimises the development of browning flavours (Maillard reactions) or the caramelisation of sugars. The crumb process on the other hand enhances the development of superior tasting complex flavours

Other benefits to the crumb process include that crumbs are stable when dry and provide a convenient storage medium for milk-based components. For example, milk chocolate crumb and white crumb can typically be stored for longer periods than dried milk powder, without milk fat rancidity or staleness developing. Further, milk chocolate and white chocolate can be obtained by simplified and rapid processing methods, when a pre-manufactured chocolate crumb is used as the primary ingredient of the chocolate. However, whilst milk chocolate and white chocolate products are a popular choice for many, some individuals cannot, or choose not to, consume products that contain milk or its derivatives. This may be due to personal preferences, dietary restrictions, allergies or intolerances.

In the past, such individuals were limited to the consumption of plain chocolate (also referred to as dark chocolate) but there are now a growing number of other dairy-free confectionery products available that are more analogous to milk chocolate and white chocolate. These dairy-free alternatives to milk chocolate and white chocolate are generally prepared using a dry process, similar to the one outlined above for the production of milk chocolate and white chocolate, but different in that the dairy-based ingredients, such as full cream milk powder, skimmed milk powder, lactose powder and other milk components, are substituted with dry, plant-derived ingredients such as starches, cereal flours, defatted nut flours, syrup solids or other processed dry plant-derived materials.

For example, a dairy-free alternative to white chocolate is conventionally obtained by mixing vegetable fats, such as cocoa butter, together with dry ingredients such as sugar, rice syrup solids, rice starch and rice flour. The mixture is then refined to reduce particle size, and conched to produce a liquid chocolate, which thereafter, and where necessary is generally then tempered before forming finished products. The production of a dairy-free alternative to milk chocolate typically follows the same process for the production of a dairy-free alternative to white chocolate, but includes the addition of cocoa liquor, cocoa nibs or cocoa powder in the mix.

For example, EP3685673 discloses such a process for the production of dairy-free chocolate, wherein dry ingredients are mixed. In EP3685673 dry hydrolyzed oatmeal is mixed with dry sugar and cocoa butter/mass to form a plant-based chocolate, in the conventional manner.

The use of such methods has various limitations, for example in terms of the consistency and flavour which can be achieved in the resulting dairy-free chocolate products, as well as in ease of processing. There is a therefore a need for an improved method for the production of dairy-free alternatives to milk and white chocolate.

The present invention has been devised in light of the above considerations.

### SUMMARY OF THE INVENTION

Surprisingly, the current inventors have found that, by performing certain treatment steps on a plant-based milk, it is possible to produce a novel dairy-free chocolate crumb therefrom, which can advantageously be utilised in improved production methods for dairy-free chocolate.

As described above, for dairy-containing chocolate products, the use of the so-called “crumb process” is known. However, there are several barriers to the production of a dairy-free alternative to milk chocolate or white chocolate by a crumb process, meaning that it cannot simply be applied to dairy-free ingredients. To date, commercially available plant-based alternatives to milk and white chocolate have only been produced using a dry process, as described above.

U.S. Pat. No. 9,655,374 discloses a process for producing a dairy-free “chocolate food product” which involves the mixing and heating of molten/liquid ingredients, but does not disclose a step of forming a crumb (i.e. a stable, co-dried, mixture of milk, cocoa solids, and sugar).

Liquid dairy milk and dairy milk-derived hydrous ingredients differ significantly from so called “plant milks” (plant-based alternatives to milk, i.e. plant substrate suspensions), as far as their biological, physical, chemical and physiological characteristics are concerned. As such, they require significantly different handling and processing.

Ultimately, plant-based alternatives to milk are suspensions of dissolved and disintegrated plant matter that merely resemble milk in appearance. They are typically manufactured through water-based extracts of, for example, cereals, legumes, oil seeds, nuts, tubers or pseudo-cereals. They can generally be prepared by crushing plant material followed by extraction of its soluble and disintegrated solids into water. The properties of the plant substrate suspension depend largely on the raw materials used, as well as the formulation and processing applied, and are different from the properties of dairy milk.

Importantly, plant-based alternatives to milk do not contain lactose, which plays a key role in the Maillard reactions that give chocolates produced by a crumb process the complex flavour volatiles described above.

Additionally, plant-based alternatives to milk are incompatible with the co-drying step of the crumb process. Unlike milk, plant substrate suspensions based on extracts of starchy materials (such as cereals, tubers or pseudo-cereals) gelatinize when heated in the presence of water, creating an undesirable texture and viscosity which makes subsequent processes such as drying of the mass and crystallisation of the sucrose extremely difficult.

Further, plant-based alternatives to milk made from high protein materials such as soya can develop undesirable flavours due to the action of a lipoxidase (found only in plants) which catalyzes the oxidation of unsaturated fatty acids when it comes into contact with them in the presence of water. Plant-based alternatives to milk made from high fat materials such as nuts and seeds may also suffer from an undesirable phase separation of the plant-based milk and/or a resulting chocolate, leading to the production of a product with reduced product stability.

The present inventors have overcome these difficulties and developed processes which enable the production of a “crumb” from a plant substrate suspension (i.e. from plant-based milks). The crumb is suitable for the production of plant-based (i.e. dairy free) alternatives to milk and white chocolate, which have improved properties (e.g. in terms of their organoleptic and sensory properties) compared to currently available dairy-free chocolate products.

It is acknowledged that WO2021/069804, which was published after the priority date of the present application, discloses a grain-based (specifically, oat- or rye-based) crumb, methods for its preparation, and the use of the grain-based crumb in food applications. No disclosure of any crumbs made without grains is provided in this document. Furthermore, the processes and crumbs of the present invention can be distinguished from those of WO2021/069804 in a number of ways, as detailed herein.

Accordingly, in some aspects of the invention, provided herein is a process for making a plant-based crumb, i.e. a crumb based on a plant-based milk, wherein said plant-based milk comprises an aqueous suspension of plant material.

In some embodiments, the process for producing a crumb based on a plant-based milk as described herein comprises the steps of:
liquefaction, wherein polysaccharides in the plant material are liquefied by one or more enzymes; and/or
saccharification, wherein reducing sugars are liberated from the plant material by one or more enzymes;
and crumb formation, wherein the plant-based milk is heated and dried to a crumb.

In some embodiments, a liquefaction step is performed.

In some embodiments, a saccharification step is performed.

Preferably, both a saccharification and a liquefaction step are performed.

Preferably, the crumb is a dairy-free crumb. More preferably, the crumb is a dairy-free chocolate crumb or a dairy-free white crumb. In some preferred embodiments the crumb is a vegan crumb. More preferably, the crumb is a vegan milk chocolate crumb or a vegan white crumb.

Advantageously, by using a process described herein a plant-based milk is produced with an appropriate composition for the production of a “crumb” and hence a chocolate with superior flavour properties. For example, a plant-based milk prepared as described herein comprises reducing sugars, such as maltose, with carbonyl groups which can react with the nucleophilic amino group of an amino acid via Maillard reactions, to create new flavour profiles.

In some embodiments, the saccharification step comprises one or more enzyme treatments, for example treatment with one or more amylase enzymes, wherein the amylase enzyme is preferably a fungal-derived α-amylase, or a β-amylase.

In some embodiments, the liquefaction step comprises one or more enzyme treatments, for example treatment with one or more amylases enzymes, preferably α-amylase enzymes, wherein the α-amylase enzyme is preferably a bacteria-derived α-amylase. In some embodiments, the liquefaction step further comprises treatment with one or more glucanase enzymes, preferably β-glucanase enzymes, wherein the β-glucanase is preferably a bacteria-derived β-glucanase.

It is noted that U.S. Pat. No. 4,894,242 (which is incorporated herein by reference) describes a method for producing an improved rice-based beverage, said method comprising a step of liquefying with α-amylase enzymes and a subsequent treatment of the rice-based beverage with a glucosidase enzyme and/or a β-amylase enzyme in a saccharifying step. However, there is no suggestion in that document to use the resulting “rice liquids” in the production of a crumb for making chocolate. Similarly, US 2007/014892 discloses a whole grain non-dairy milk powder wherein rice milk or corn milk has been liquefied and saccharified and then spray dried; CN 108 835 263 discloses the formation of a rice-type black bean-milk powder, which involves liquefaction of a slurry of black beans, followed by spray drying; US 2002/081367 relates to a milk substitute cereal dispersion prepared by enzymatic hydrolysis; and CN 108 967 547 relates to a preparation method of high-glycoside isoflavone soybean milk powder, involving enzymatic hydrolysis. None of these documents suggest the production of a plant-based crumb.

The present inventors have surprisingly discovered that plant material which has undergone a liquefaction and/or saccharification step and been formulated into a plant-based milk as described herein may be converted to a crumb, suitable for the production of significantly improved plant-based chocolate products.

In some embodiments, the process further comprises at least one protein adjustment step.

In some embodiments, the process further comprises the addition of a sweetening composition, which preferably comprises sucrose.

In some embodiments, the process optionally further comprises a defatting step.

In some embodiments, the process further comprises a step of blending plant-based materials and/or plant-based milks.

In some embodiments, crumb formation comprises:
evaporation to form a condensed plant-based milk;
optionally, adding cocoa solids to the condensed plant-based milk;
heating the condensed plant-based milk;
drying the condensed plant-based milk, preferably to a moisture content below about 5%, more preferably to a final moisture content of about 1-3%.

In a further aspect, the invention provides a plant-based crumb i.e. a crumb formed from a plant-based milk, as described herein (i.e. prepared as described herein and/or having a composition and properties as described herein). In some embodiments, the crumb is obtained by a process as described herein. In some embodiments, the crumb is obtainable by a process as described herein.

Preferably, the crumb is a dairy-free crumb. More preferably, the crumb is a dairy-free chocolate crumb or a dairy-free white crumb. In some preferred embodiments, provided herein is a vegan crumb. More preferably, provided herein is a vegan chocolate crumb or a vegan white crumb. In some preferred embodiments, provided herein is a vegan, allergen-free crumb. More preferably, provided herein is a vegan, allergen-free chocolate crumb or a vegan, allergen-free white crumb.

In another aspect, provided herein is the use of a crumb based on a plant-based milk, for example a plant-based crumb as described herein, in a process for making chocolate (i.e. a plant-based chocolate). Also provided herein is a process for making chocolate using a plant-based milk (i.e. a process for making a plant-based chocolate).

In some embodiments the process comprises mixing the crumb with a fat.

Preferably, the process is for making a dairy-free chocolate. More preferably the dairy-free chocolate is a dairy-free milk chocolate or a dairy-free white chocolate. In some preferred embodiments, the process is for making a vegan chocolate. More preferably, the vegan chocolate is a vegan milk chocolate or a vegan white chocolate. In some preferred embodiments, the process is for making a vegan, allergen-free chocolate. Most preferably, the chocolate is a vegan, allergen-free milk chocolate or a vegan, allergen-free white chocolate.

In some aspects, the invention provides a plant-based chocolate, i.e. a chocolate made using a plant-based milk, as described herein (i.e. prepared as described herein and/or having a composition and properties as described herein). In some embodiments the chocolate is obtained by a process as described herein. In some embodiments the chocolate is obtainable by a process as described herein.

Preferably, the chocolate is a dairy-free chocolate. More preferably the dairy-free chocolate is a dairy-free milk chocolate or a dairy-free white chocolate. In some preferred embodiments the chocolate is a vegan chocolate. More preferably, the vegan chocolate is a vegan milk chocolate or a vegan white chocolate. In some preferred embodiments, the chocolate is a vegan, allergen-free chocolate. Most preferably, the chocolate is a vegan, allergen-free milk chocolate or a vegan, allergen-free white chocolate.

The invention includes the combination of the aspects and preferred features described except where such a combination is clearly impermissible or expressly avoided.

### DETAILED DESCRIPTION OF THE INVENTION

Aspects and embodiments of the present invention will now be discussed in detail. Further aspects and embodiments will be apparent to those skilled in the art. All documents mentioned in this text are incorporated herein by reference.

In the context of food labelling it is recognised that the use of certain terms, such as “chocolate”, “milk chocolate”, “white chocolate” and “milk”, is regulated (for example according to EU Directive 2000/36/EC and EU Regulation 853/2004). Hence, on ingredients listings and labels for commercial food products, the use of these terms is restricted to particular ingredients and products, falling within the strict regulatory definitions.

For the purposes of describing the present invention, however, and in the interests of clarity and simplicity, these restrictive classifications have not been strictly followed. Accordingly, the following terms are defined herein:

The term “cocoa butter” (also referred to as “cocoa fat”) refers to fat derived from the seed of the Theobroma Cacao tree.

The term “cocoa solids” as used herein, when not prefaced with the words “dry non-fat”, refers to any or all components of the seed of the Theobroma Cacao tree processed as appropriate to produce various ingredients including cocoa beans, cocoa nibs, cocoa liquor (also referred to as cocoa mass), cocoa butter (also referred to as cocoa fat), cocoa powder, cocoa fibre, other cocoa based or cocoa containing ingredients or combinations thereof.

The term “dry non-fat cocoa solids” refers to the cocoa parts remaining after the removal of substantially all moisture and fats from the cocoa solids.

The term “chocolate” as used herein refers to a confectionery comprising, cocoa butter (or cocoa butter alternatives), sugars, and optionally cocoa solids. Examples might include, but are not limited to, milk chocolate, white chocolate, couverture chocolate, compound chocolate, enrobing chocolate, or chocolate-like products.

Unless the context clearly dictates otherwise, the term “milk” as used herein, when not prefaced with the words “plant-based”, “dairy-free” or “vegan”, refers to “dairy milk” i.e. a fluid containing fats and proteins secreted from the mammary glands of female mammals. The term also includes products derived from dairy milk such as fresh milk, skimmed milk, buttermilk, cultured milk, evaporated milk, reconstituted milk obtained by rehydrating powdered milk and powdered (dehydrated) milk products e.g. full cream milk powder, skimmed milk powder, milk proteins, milk sugars and lactose powder.

The terms “plant-based milk”, “plant-based milk alternative” or “plant-based alternative to milk”, as used herein, refer to an aqueous suspension of plant material (i.e. of edible plant extracts) which can resemble dairy milk in appearance. Corresponding terms are used to describe products derived from plant-based milk.

The term “dairy-free” as used herein refers to the absence of milk and products derived from milk (such as, but not limited to, skimmed milk, buttermilk, cultured milk, milk powder, milk proteins and milk sugars (i.e. lactose)).

The term “vegan” as used herein refers to the absence of animal products, including milk, its components and its derivatives as well as any other animal-derived products.

The term “dairy-free chocolate” as used herein refers to a confectionery comprising cocoa butter (or cocoa butter alternatives), sugars (and optionally cocoa solids) and which does not comprise dairy milk or the components thereof.

The term “vegan chocolate” as used herein refers to a confectionery comprising cocoa butter (or cocoa butter alternatives), sugars (and optionally cocoa solids) which does not comprise animal-derived products.

The term “milk chocolate” as used herein refers to a confectionery comprising cocoa butter (or cocoa butter alternatives), cocoa solids, sugar, dairy milk and/or plant-based milk (as context dictates).

The term “white chocolate” as used herein refers to a confectionery comprising cocoa butter (or cocoa butter alternatives), sugar, dairy milk and/or plant-based milk (as context dictates).

The term “cocoa butter alternatives” can comprise Cocoa Butter Substitute (CBS), Cocoa Butter Replacer (CBR) or Cocoa Butter Equivalent (CBE) or other cocoa butter alternatives commonly known in the art.

The term “dairy-free milk chocolate” as used herein refers to a confectionery comprising cocoa butter (or cocoa butter alternatives), cocoa solids, sugar and plant-based milk, and which does not comprise dairy milk.

The term “vegan milk chocolate” as used herein refers to a confectionery comprising cocoa butter (or cocoa butter alternatives), cocoa solids, sugar and plant-based milk, and which does not comprise animal derived products.

The term “dairy-free white chocolate” as used herein refers to a confectionery comprising cocoa butter (or cocoa butter alternatives), sugar and plant-based milk, and which does not comprise dairy milk.

The term “vegan white chocolate” as used herein refers to a confectionery comprising cocoa butter (or cocoa butter alternatives), sugar, and plant-based milk, and which does not comprise animal derived products.

The term “crumb” as used herein refers to a co-dried mixture comprising sugar, dairy milk and/or plant-based milk, and optionally cocoa solids.

The term “chocolate crumb” as used herein refers to a co-dried mixture comprising sugar, dairy milk (and/or plant-based milk as context dictates) and cocoa solids, which is suitable for use in making a milk chocolate.

The term “plant-based crumb” or “plant-based chocolate crumb”, as used herein refers to a co-dried mixture comprising sugar, plant-based milk, and optionally cocoa solids.

The term “dairy-free crumb” or “dairy-free chocolate crumb” as used herein refers to a co-dried mixture comprising sugar, plant-based milk and optionally cocoa solids, and which does not comprise dairy milk.

The term “vegan crumb” or “vegan chocolate crumb” as used herein refers to a co-dried mixture comprising sugar, plant-based milk and optionally cocoa solids, and which does not comprise animal derived products

The term “white crumb” as used herein refers to a co-dried mixture comprising sugar and dairy milk (and/or plant-based milk as context dictates).

The term “dairy-free white crumb” as used herein refers to a co-dried mixture comprising sugar and plant-based milk, and which does not comprise dairy milk.

The term “vegan white crumb” as used herein refers to a co-dried mixture comprising sugar and plant-based milk and which does not comprise animal derived products.

The terms “cereal-free”, “grain-free”, “made without cereals” or “made without grains” refers to the absence of grains (seeds) cultivated from grasses (family Poaceae) such as wheat, barley, rye, rice and oats. The term “gluten-free” as used herein refers to products with 20 parts per million (ppm) or less of gluten. The term “low gluten” as used herein refers to products with between 21 and 100 ppm of gluten. The term “allergen free” refers to the absence of any of EU declared allergens.

Contents expressed as percentages herein are by weight (% w/w) unless otherwise stated.

The plant-based milk used in the processes, crumbs and chocolates described herein may comprise any suitable plant material, i.e. any edible material derived from plants.

Plant-based milks are known and many are commercially available. Plant-based milks may also be produced, for example, using a process as described below.

In some embodiments, the plant-based milk for use in the present invention is an aqueous suspension derived from at least one plant material. In some embodiments, the plant-based milk comprises material derived from cereals, tubers, pseudo-cereals, legumes, oil seeds, nuts, or combinations thereof. In some embodiments the plant material is derived from cereals, tubers, pseudo-cereals, nuts or combinations thereof.

In some embodiments it is preferable for the plant-based milk to comprise a high starch plant material e.g. derived from a high starch cereal, tuber, nut or pseudo-cereal.

In some embodiments it is preferable for the plant-based milk to comprise tubers, nuts, legumes, or combinations thereof. In some embodiments it is preferable for the plant-based milk to comprise tubers e.g. tiger nuts.

In some embodiments it is preferable for the plant-based milk to be gluten-free. In some embodiments it is preferable for the plant-based milk to be low in gluten. In these embodiments the plant-based milk comprises a gluten-free or low gluten plant material. It can be advantageous to have a low level of gluten in the plant-based milks, crumbs and chocolates described herein as the presence of excess gluten proteins can affect the texture and mouthfeel of a confectionery.

For example, in some embodiments the plant-based milk comprises rice, nuts, legumes, tubers, gluten-free preparations of oats or combinations thereof. In some embodiments the plant-based milk comprises rice, nuts, legumes, tubers or combinations thereof.

In some embodiments the plant-based milk comprises rice.

In some embodiments the plant-based milk comprises at least one nut.

In some embodiments the plant-based milk comprises at least one legume.

In some embodiments the plant-based milk comprises at least one tuber.

If the plant-based milk comprises oats, it is preferable that a “gluten-free” oat material is used. It is commonly understood in the art that although oats do not contain gluten per se, most commercially sourced oat preparations are contaminated with gluten-containing grains, which can be harmful to individuals with coeliac disease or gluten intolerances, due to their processing and growing conditions. With the exception of rice, all cereals, including oats, are considered to be allergens under EU definitions.

In some embodiments it is preferable for the plant-based milk to be cereal-free.

In some embodiments it is preferable for the plant-based milk to be grain-free.

In some embodiments it is preferable for the plant-based milk to be allergen-free.

For example, in some embodiments the plant material comprises tiger nut and/or the adjuvant plant material comprises sunflower seeds. Beneficially, tiger nuts and sunflower seeds are not considered to be allergens in the EU.

In some embodiments the plant material comprises tiger nuts, sweet potato, rice, oats, amaranth, teff, sorghum, quinoa, buckwheat or combinations thereof.

In some embodiments the plant material comprises tiger nuts, sweet potato, oats, rice, sorghum or combinations thereof.

In some embodiments the plant material comprises tiger nuts, sweet potato, rice, sorghum, or combinations thereof.

In some embodiments the plant material comprises tiger nuts, sweet potato, rice or combinations thereof.

In some embodiments the plant material comprises tiger nuts, sweet potato, or combinations thereof.

In some preferred embodiments the plant material comprises rice, oats, sorghum or combinations thereof.

In some preferred embodiments the plant material comprises rice, oats, tiger nut or combinations thereof.

In some preferred embodiments the plant material comprises rice, oats or combinations thereof.

In some preferred embodiments the plant material comprises tiger nut, oats or combinations thereof.

In some preferred embodiments the plant material comprises tiger nut, rice or combinations thereof.

In some embodiments the plant material comprises tiger nuts. Tiger nuts are the small root nodules (tubers) that grow at the base of the sedge grass Cyperus esculentus. Advantageously, tiger nuts have a unique flavour and high levels of both starch and sucrose.

In some embodiments the plant material comprises sweet potato. Advantageously, sweet potatoes have high levels of naturally occurring sucrose and high levels of starch to maltose conversion when cooked.

In some embodiments the plant material comprises rice. Advantageously, rice has a neutral flavour and high total solids yields during water based extractions.

In some embodiments the plant material comprises oats. Advantageously, oats have a desirable flavour, a high protein content (relative to rice) and high total solids yields during water based extractions.

In some embodiments the plant material comprises sorghum. Advantageously, sorghum has a mild flavour and high total solids yields during water based extractions.

In some embodiments the plant material can be polished (i.e. bran has been removed from the surface of a plant material such as rice or tiger nuts). In other embodiments the plant material can be unpolished.

It is envisioned that different combinations and proportions of the plant materials may be used in the plant-based milks described herein, depending on the desired flavour, nutritional composition, taste profile and characteristics required in the final products. Combinations of different plant materials may be used depending on the flavour, processing characteristics or variations in local availability. As described herein the confectionery maker can combine these raw materials in any proportion to achieve the desired nutritional composition and taste profile.

In some embodiments, a plant-based milk comprising a combination of more than one plant material may be prepared by combining said plant materials before production of the plant-based milk (i.e. by combining the plant materials prior to their suspension in water). In other embodiments, a plant-based milk comprising a combination of more than one plant material may be prepared by producing one or more different plant-based milks separately (i.e. preparing more than one aqueous suspension, each containing different plant materials) then combining these plant-based milks.

In some embodiments an adjunct plant material may be used in the processes, plant-based milks, crumbs and chocolates described herein. In some embodiments the adjunct plant material may comprise legumes, oil seeds, nuts or combinations thereof. In some embodiments the adjunct plant material may comprise hazelnuts, peanuts, cashew nuts, macadamia nuts, coconuts, almonds, chickpeas, peas, soya, hemp seeds, sunflower seeds, sesame seeds or combinations thereof.

Advantageously, adjunct plant materials may be included in the plant-based milks, crumbs or chocolates described herein to improve flavour or to boost protein content. Adjunct plant materials may also provide additional functional benefits. In some embodiments the adjunct plant material may be roasted to further improve the flavour contributions provided by the adjunct plant material.

It is preferable for the total dry weight of the adjunct plant material to make up between 0% and 20% of the weight of the final chocolate. It is preferable for the total dry weight of the adjunct plant material to make up between 1% and 10% of the weight of the final chocolate. It is preferable for the total dry weight of the adjunct plant material to make up between 2% and 8% of the weight of the final chocolate. It is preferable for the total dry weight of the adjunct plant material to make up between 0% and 30% of the weight of the crumb. It is preferable for the total dry weight of the adjunct plant material to make up between 1% and 20% of the weight of the crumb. It is preferable for the total dry weight of the adjunct plant material to make up between 5% and 10% of the weight of the crumb.

In some preferred embodiments the adjunct plant material comprises hazelnut. In some preferred embodiments the adjunct plant material comprises almond. In some preferred embodiments the adjunct plant material comprises sunflower seeds. In some preferred embodiments the adjunct plant material comprises a combination of hazelnut and sunflower seeds.

In some embodiments the plant material comprises tiger nut and/or rice and the adjunct plant material comprises hazelnut.

In some embodiments the plant material comprises tiger nut and the adjunct plant material comprises hazelnut.

In some embodiments the plant material comprises tiger nut and the adjunct plant material comprises sunflower seeds.

In some embodiments the plant material comprises tiger nut and the adjunct plant material comprises hazelnut and sunflower seeds.

In some embodiments the plant material comprises oats and/or rice.

In some embodiments the plant material comprises oats and/or tiger nut.

In some embodiments the plant material comprises rice and the adjunct plant material comprises almonds.

A process for the production of a plant-based milk, as described herein, may comprise a pre-grinding or milling step.

In some embodiments the plant material is pre-ground to a particle size of between about 50 and about 1000 microns. In some embodiments the plant material is pre-ground to a particle size of between about 50 and about 200 microns. In some embodiments the plant material is pre-ground to a particle size of between about 50 and about 800 microns. In some embodiments the plant material is pre-ground to a particle size of between about 100 and about 800 microns. In some embodiments the plant material is pre-ground to a particle size of between about 200 and about 800 microns. In some embodiments the plant material is pre-ground to a particle size of between about 50 and about 500 microns. In some embodiments the plant material is pre-ground to a particle size of between about 100 and about 500 microns. In some embodiments the plant material is pre-ground to a particle size of between about 200 and about 500 microns.

In some embodiments the pre-grinding or milling step is performed use a dry mill to grind the plant material. In some alternative embodiments pre-ground plant materials may be purchased commercially. In some embodiments, partial defatting may be required, and can be performed prior to dry milling or dry grinding using e.g. a screw oil press. In some alternative embodiments pre-ground partial defatted plant material may be purchased commercially.

In some alternative embodiment, the plant material is pre-soaked in water. In some embodiments the plant material is soaked in water for between about 6 hours and about 24 hours. In some embodiments the plant material is soaked in water for between about 6 hours and about 12 hours. In some embodiments the plant material is soaked in water for between about 6 hours and about 10 hours. In some embodiments the plant material is soaked in water for between about 6 hours and about 8 hours. In some embodiments the water may comprise agents for enhancing or controlling the soaking process e.g. agents which prevent unwanted reactions or fermentations of the plant material during or after soaking. Preferably, the whole (i.e. not milled or ground) plant material is pre-soaked. After pre-soaking, the plant material is preferably drained of excess water.

To produce a plant-based milk, particles of the plant material are suspended in water. In some embodiments one or more enzymes suitable for performing a liquefaction and/or a saccharification step are added to the water before particles of the plant material are suspended in the water. In some embodiments enzymes suitable for performing the liquefaction and/or a saccharification step are added to the water after particles of the plant material are suspended in the water. In some embodiments the (optionally pre-ground and/or pre-soaked) plant material is suspended in water and then milled/blended to form the plant-based milk. In some embodiments one or more enzymes suitable for performing the liquefaction and/or a saccharification step are added to the plant-based milk.

In some embodiments the plant material is initially suspended in water at a temperature between about 10° C. and about 50° C. In some embodiments the plant material is initially suspended in water at a temperature between about 20° C. and about 50° C. In some embodiments the plant material is initially suspended in water at a temperature between about 20° C. and about 47° C. In some embodiments the plant material is initially suspended in water at a temperature between about 25° C. and about 40° C. In some embodiments the plant material is initially suspended in water at a temperature between about 30° C. and 45° C. In some embodiments the plant material is initially suspended in water at a temperature between about 35° C. and 45° C.

In some alternative embodiments the plant material is suspended in water at a temperature between about 10° C. and about 150° C. In some embodiments the plant material is suspended in water at a temperature between about 10° C. and about 120° C. In some embodiments the plant material is suspended in water at a temperature between about 10° C. and about 100° C. In some embodiments the plant material is suspended in water at a temperature between about 10° C. and about 80° C. In some embodiments the plant material is suspended in water at a temperature between about 20° C. and about 150° C. In some embodiments the plant material is suspended in water at a temperature between about 20° C. and about 120° C. In some embodiments the plant material is suspended in water at a temperature between about 20° C. and about 100° C. In some embodiments the plant material is suspended in water at a temperature between about 20° C. and about 80° C. In some embodiments the plant material is suspended in water at a temperature between about 10° C. and about 55° C. In some embodiments the plant material is suspended in water at a temperature between about 20° C. and about 55° C.

In some embodiments it may be preferable to heat the plant material suspension to a temperature which can denature enzymes which can interfere with a preferred taste or texture of the plant-based milk, crumb or chocolate obtained by the process described herein. For example, it may be preferable to heat aqueous suspensions of plant materials which comprise soya beans to denature lipoxidase enzymes which catalyse the oxidation of unsaturated fatty acids in the presence of water, causing a bitter taste. U.S. Pat. No. 4,194,018A (Hodel et al. 1980; incorporated herein by reference) describes a process for the production of an aqueous soya suspension, in which bitter notes are eliminated, through the dispersion of particles, heating and flushing.

In some embodiments the suspended plant material is milled, ground or blended, for example using a high shear grinder or blender, to form a slurry. In some embodiments ultrasound may be used during, before or after the milling, grinding or blending step. Without wishing to be bound by theory, it is thought that ultrasound may increase the dispersion and emulsification of the plant-based milk by increasing the permeability of plant cell walls through ultrasound cavitation effects.

In some embodiments the ratio of the dry weight of plant materials to the weight of water used to prepare the milk is between about 1:0.1 to about 1:6. In some embodiments the ratio of the dry weight of plant materials to the weight of water used to prepare the milk is between about 1:0.3 to about 1:6. In some embodiments the ratio of the dry weight of plant materials to the weight of water used to prepare the milk is between about 1:0.5 to about 1:6. In some embodiments the ratio of the dry weight of plant materials to the weight of water used to prepare the milk is between about 1:0.7 to about 1:6. In some embodiments the ratio of the dry weight of plant materials to the weight of water used to prepare the milk is between about 1:0.9 to about 1:6 In some embodiments the ratio of the dry weight of plant material which is suspended in water to produce the plant-based milk, to the weight of water, is between about 1:1 to about 1:6. In some embodiments the dry weight ratio of plant material to water is between about 1:1 to about 1:4. In some embodiments the dry weight ratio of plant material to water is between about 1:2 to about 1:4. In some embodiments the dry weight ratio of plant material to water is about 1:3. In some embodiments the dry weight ratio of plant material to water is about 1:2. In some embodiments the dry weight ratio of plant material to water is about 1:1. In some embodiments the dry weight ratio of plant material to water is about 1:0.9. In some embodiments the dry weight ratio of plant material to water is about 1:0.7. In some embodiments the dry weight ratio of plant material to water is about 1:0.5. In some embodiments the dry weight ratio of plant material to water is about 1:0.3. In some embodiments the dry weight ratio of plant material to water is about 1:0.1.

In some embodiments the plant-based milk may be subjected to a separating step to remove or segregate oversized materials. This may comprise one or more filtering, decanting or centrifugation procedures or combinations thereof. The benefit of performing a separating step is that coarse particles (e.g. residual plant cellulose) can be removed from the plant-based milk. In some preferred embodiments the separating step comprises filtering, for example using a suitable mesh. In some embodiments, after the removal of oversized particles, the desired maximum suspended particle size in the plant-based milk is below 300 microns. In some embodiments the desired maximum suspended particle size in the plant-based milk is below 100 microns. In some embodiments the desired maximum suspended particle in the plant-based milk is below 50 microns.

Without wishing to be bound by theory, it may be particularly useful to perform a separation step when a plant material used in the invention has a high fibre content. The oversized material removed in the separation step may comprise a large amount of insoluble fibres. By segregating the insoluble fibre from the milk, the proportion of carbohydrates, sugar, protein, fats and other flavour volatile compounds can be increased in the milk, concentrating the overall flavour intensity of the milk. Plant materials with a high fibre content include, but are not limited to, tiger nut.

In other embodiments, for example where the plant material has a low insoluble fibre content, a separating step is not performed. In such embodiments, insoluble fibre from the plant material is retained in the milk. Plant materials with a low insoluble fibre content include, but are not limited to, rice (in particular, polished rice).

In some embodiments the separating step, if present, may be performed before a liquefaction and/or saccharification step. In some embodiments the separating step, if present, may be performed after a liquefaction and/or saccharification step.

A plant-based milk which has not undergone a separating step may have a higher total solids content than a plant-based milk which has undergone a separation step. For example, a plant-based milk which has not undergone a separation step may have a total solids content up to about 90%.

In some embodiments, prior to the addition of other ingredients, the total solids content of plant-based milk is between about 10% and about 90%. In some embodiments, prior to the addition of other ingredients, the total solids content of plant-based milk is between about 10% and about 80%. In some embodiments, prior to the addition of other ingredients, the total solids content of plant-based milk is between about 10% and about 70%. In some embodiments, prior to the addition of other ingredients, the total solids content of plant-based milk is between about 20% and about 90%. In some embodiments, prior to the addition of other ingredients, the total solids content of plant-based milk is between about 20% and about 80%. In some embodiments, prior to the addition of other ingredients, the total solids content of plant-based milk is between about 20% and about 70%.

In some embodiments, after a separating step (i.e. after the removal of oversized particles, but prior to addition of other ingredients, such as sweeteners), the plant-based milk preferably has a total solids content of between about 10% and about 50% by weight. In some embodiments, the plant-based milk preferably has a total solids content of between about 15% and about 35% by weight, more preferably from about 20% to about 30% by weight.

In some embodiments, the fibre content of a plant-based milk suitable for use in the crumb formation process of the present invention is from about 0% to about 10% dry weight. In some embodiment, the fibre content of the plant-based milk is about 3% to about 8% dry weight. In some embodiment, the fibre content of the plant-based milk is about 2% to about 7% dry weight. In some embodiment, the fibre content of the plant-based milk is about 0% to about 8% dry weight. In some embodiment, the fibre content of the plant-based milk is about 0% to about 7% dry weight. In some embodiments, for example where the plant-based milk has undergone a separation step, the fibre content of the plant-based milk may be less than about 1%.

The fibre content of the plant-based milk is the primary factor in determining the fibre content of the resulting crumb and chocolate (although it will be understood that fibre may in principle be added to the crumb or to the chocolate, if desired).

In some embodiments, the total fibre content of a crumb of the present invention is from about 0% to about 10% based on the total weight of the crumb. In some embodiments, the fibre content of the crumb is from about 0% to about 8% based on the total weight of the crumb. In some embodiments, the fibre content of the crumb is from about 0% to about 7% based on the total weight of the crumb. In some embodiments, the fibre content of the crumb is from about 1% to about 8% based on the total weight of the crumb. In some embodiments, the fibre content of the crumb is from about 1.5% to about 7.5% based on the total weight of the crumb. In some embodiment, the fibre content of the crumb is about 2.5% to about 7% based on the total weight of the crumb. In some embodiment, the fibre content of the crumb is about 2.5% to about 6.7% based on the total weight of the crumb.

In some embodiments, the total fibre content of a chocolate of the present invention is from about 0% to about 10% based on the total weight of the chocolate. In some embodiments, the fibre content of the chocolate is from about 1% to about 7% based on the total weight of the chocolate. In some embodiments, the fibre content of the chocolate is from about 2% to about 5% based on the total weight of the chocolate.

A plant-based milk produced using a process as described above is particularly suitable for use in the production of plant-based crumbs and chocolates, as further described below. It will be understood, however, that other plant-based milks, for example plant-based milks produced using other known methods, commercially available plant-based milks, commercially available condensed plant-based milks and/or mixtures of plant-based milks and condensed plant-based milks (including mixtures of other (condensed) plant-based milks and (condensed) plant-based milks as described herein), may also be used in the processes of the invention.

It will also be understood that commercially available “hydrolysed” flours (i.e. flours based on plant materials, on which a liquefaction and/or a saccharification step have already been performed) may in principle be used in the processes of the invention. For example, a commercially available hydrolysed flour (such as, for example, a hydrolysed rice flour) may be suspended in water and then further steps of the process as described herein applied as required to the resultant suspension, to form a plant-based milk, a plant-based crumb and/or a plant-based chocolate according to the present invention.

In some embodiments, it may be advantageous to include a protein adjustment step in order to increase the amount of short chain proteins, oligopeptides, peptides and amino acids in the plant-based milks, chocolate crumbs and chocolates obtained or obtainable by the process described herein. Without wishing to be bound by theory, it is thought that, by increasing the number of amino groups available, the number of Maillard reactions that can occur is increased and the flavour profile of a crumb and chocolate obtained therefrom can be further improved.

In some embodiments, therefore, the process described herein may comprise one or more protein adjustment steps. In some embodiments a protein adjustment step is performed after a separating step.

In some embodiments a protein adjustment step is performed before a separating step. In some embodiments a protein adjustment step is performed after a liquefaction and/or saccharification step.

In some embodiments the protein adjustment step comprises a protein hydrolysis step. In some embodiments the protein hydrolysis step comprises hydrolysing proteins in a plant material using one or more enzymes. In some embodiments, the protein hydrolysis step comprises treating a plant-based milk with at least one enzyme, in order to increase the content of free amino acids in the plant-based milk. In some embodiments, the protein hydrolysis step comprises treating a plant material with at least one enzyme, in order to increase the content of free amino acids in a plant-based milk produced from said plant material. In some embodiments the enzyme is selected from papain and carboxypeptidase. In some embodiments the enzyme is papain. In some embodiments the enzyme is a carboxypeptidase. In some embodiments the enzyme has an activity of greater than 100 U/g.

In some embodiments the protein hydrolysis step is conducted at a pH of between about 3 and about 9.

In some embodiments the protein hydrolysis step is conducted at a pH of between about 4 and about 5.

In some embodiments, during the protein hydrolysis step, the plant-based milk is heated to a temperature of between about 10° C. and about 100° C. In some embodiments the plant-based milk is heated to a temperature of about 50° C. In some embodiments the plant-based milk is heated for between about 2 hour and about 12 hours. In some embodiments the plant-based milk is heated for between about 4 and about 10 hours. In some embodiments the plant-based milk is heated for between about 6 and about 8 hours. In preferred embodiments, the plant-based milk is heated for between about 6 and about 8 hours at a temperature of about 50° C.

In some embodiments the protein adjustment step comprises a step of adding protein hydrolysates and/or protein isolate to a plant material, a plant-based milk, or a condensed plant-based milk, as described herein. In some embodiments the protein hydrolysates and/or protein isolates are plant-derived protein hydrolysates and/or plant derived protein isolates. In some embodiments the protein hydrolysates and/or protein isolates are derived from soya, pea, rice or hemp proteins, or combinations thereof.

Protein hydrolysates and protein isolates are readily available commercially, from many sources, including from pea, brown rice, hemp, soya etc. They are generally produced from purified protein sources by heating with acid or addition of proteolytic enzyme, followed by purification steps.

In some embodiments the protein hydrolysates and/or protein isolates are added as a powder to the plant material, plant-based milk, or the condensed plant-based milk, as described herein.

In some embodiments the protein adjustment step comprises adjusting the protein level of a plant material or a plant-based milk to between about 1 and about 20% (dry weight). In some embodiments the plant-based milk comprises between about 3 and about 20% dry weight of protein. In some embodiments the plant-based milk comprises between about 1 and about 15% dry weight of protein. In some embodiments the plant-based milk comprises between about 1 and about 12% dry weight of protein. In some embodiments the plant-based milk comprises between about 1 and about 11% dry weight of protein.

In some embodiments the protein adjustment step comprises adjusting the protein level of a plant material or a plant-based milk such that the crumb obtained therefrom comprises between about 1 and about 20% protein, by weight. In some embodiments the crumb comprises between about 3 and about 20% by weight of protein. In some embodiments the crumb comprises between about 1 and about 15% by weight of protein. In some embodiments the crumb comprises between about 1 and about 10% by weight of protein. In some embodiments the crumb comprises between about 3 and about 10% by weight of protein. In some embodiments the crumb comprises about 7 to 8% by weight of protein. In some embodiments the crumb comprises between about 1.0 and about 11.0%. In some embodiments the crumb comprises between about 1.3 and about 10.6% by weight of protein.

In some embodiments a chocolate obtainable by a process described herein comprises between about 1 and about 20% protein, by weight. In some embodiments a chocolate obtainable by a process described herein comprises between about 1 and about 12% by weight of protein. In some embodiments a chocolate obtainable by a process described herein comprises between about 1 and about 10% by weight of protein. In some embodiments the chocolate comprises about 1 to 8% by weight of protein.

Protein content can be determined by means of Dumas (TCD) testing as accredited according to standards UNE-EN ISO/IEC 17025:2017 ENAC 1094/LE2182. Without wishing to be bound by theory it is thought that having excessive free fats in a crumb, other than those derived from cocoa, may led to fat phase separation during kneading. This in turn can negatively affect the drying of the crumb and may also have a softening effect on a resulting chocolate.

The fat content of the crumb is primarily determined by the fat content of the plant-based milk used to make it.

In some embodiments, the process of the invention optionally includes at least one defatting step, wherein the fat content of a plant material or a plant-based milk is reduced.

In some embodiments the defatting step is performed on dry plant material i.e. before, during or after the pre-grinding or soaking steps described above. In these embodiments the defatting step may be performed using an oil expeller press e.g. a screw-type oil expeller press. In some alternative embodiments partial or completely defatted plant-materials (food grade) can be purchased commercially.

In some embodiments, a defatting step may be performed on the plant-based milk. In these embodiments the defatting step may be performed, for example, using a separator.

In some embodiments it may be beneficial to blend several plant materials to form a plant-based milk with a suitable fat content. In some embodiments the plant materials may be blended before or after a step of suspending the plant materials in water.

For example, typical fat contents for milks based on particular plant materials may be as follows:
Hazelnut milk—about 65% fat on a dry weight basis
Tigernut milk—about 30% fat on a dry weight basis
Oat milk—about 5% fat on a dry weight basis
Rice Milk—about 0% fat on a dry weight basis

As will be understood by the person skilled in the art, a blended plant-based milk having a desired fat content may be produced by blending appropriate quantities of one or more different plant-based milks, including but not limited to the plant-based milks listed above, which may optionally also be fully or partially defatted.

Preferably, a plant-based milk for use in the processes of the present invention has no more than about 30% by weight of fat on a dry weight basis. In some embodiments, the plant-based milk has no more than about 20-25% by weight of fat on a dry weight basis. In some embodiments the plant-based milk has no more than about 15% by weight of fat on a dry weight basis. In some embodiments the plant-based milk has no more than about 6-12% by weight of fat on a dry weight basis.

The total fat content of the plant-based milk is determined by means of gravimetric testing as accredited according to standards UNE-EN ISO/IEC 17025:2017 ENAC 1094/LE2182. The composition of the resultant crumb's fats is then determined by means of Gas Chromatography with flame-ionization detection (GC-FID) testing according to standards UNE-EN ISO/IEC 17025:2017 ENAC 1094/LE2182.

In some embodiments, the fat content of the plant-based milk used in the processes of the invention is chosen such that the resulting crumb has no more than about 25% by weight of fat based on the total weight of the crumb. In some embodiments, the crumb has no more than about 22% by weight of fat based on the total weight of the crumb. In some embodiments the crumb has no more than about 20% by weight of fat based on the total weight of the crumb. In some embodiments, the crumb has about 5-25% by weight of fat based on the total weight of the crumb. In some embodiments, the crumb has about 5-20% by weight of fat based on the total weight of the crumb. In some embodiments, the crumb has about 5-16% by weight of fat based on the total weight of the crumb. In some embodiments, the crumb has about 10-20% by weight of fat based on the total weight of the crumb. In some embodiments, the crumb has about 10-16% by weight of fat on a dry weight basis. In some embodiments, the crumb has about 15% by weight of fat based on the total weight of the crumb.

By keeping the fat content of the crumb within the ranges described above, the crumb can readily be produced and processed and a chocolate with an excellent texture and consistency is achieved.

Without wishing to be bound by theory, if the fat levels are too high in the milk (e.g. over 30%), it can affect the drying process. Also, plant-based milk fats are predominantly unsaturated, and if the unsaturated fat levels are too high in the milk/crumb it may cause softening of the chocolate.

If the fat content of the plant-based crumb is lower than the optimum levels disclosed above, a higher quantity of fat (e.g. cocoa butter) may need to be added to the crumb at the chocolate-making stage, as described below. Alternatively, or additionally, additional fat in the form of cocoa butter can be added as an anti-foam agent during the crumb-making process, as also described below.

In some embodiments the process described herein comprises a step of sweetening the plant-based milk, crumb or chocolate described herein by addition of a sweetener/sweetening composition.

Typically a sweetener (i.e. sweetening composition) added to the plant-based milk is, or comprises, one or more carbohydrates. In preferred embodiments, the sweetener consists essentially of carbohydrates. Accordingly, and particularly with reference to those embodiments, the terms ‘sweetener’ and ‘carbohydrate’ (similarly ‘sweetener content’ and ‘carbohydrate content’) may be used interchangeably herein.

It will be understood by those skilled in the art that not all carbohydrates necessarily impart a sweet taste. This includes some carbohydrates which may be included in the sweetening composition used in the present invention. Reference herein to amounts of added ‘sweetener’, or to ‘sweetener content’ or ‘total sweetener content’ is to the total of all carbohydrates, regardless of sweetening effect.

In some preferred embodiments the sweetener is, or comprises, at least one sugar (wherein sugars include, but are not limited to, sucrose, dextrose, glucose, fructose, galactose, xylose, ribose, glyceraldehyde, lactose, cellobiose, maltotriose, maltose, tagatose, trehalose, dextrins, maltodextrins, arabinose and any combination thereof). In some preferred embodiments the sweetener comprises at least one sugar selected from sucrose, dextrose, glucose, fructose, galactose, xylose, ribose, glyceraldehyde, cellobiose, maltotriose, maltose, tagatose, trehalose, dextrins, maltodextrins, arabinose and any combination thereof. In some embodiments the sugar is a crystalline sugar.

In some embodiments the sweetener comprises a non-reducing sugar. In some embodiments the sweetener comprises a non-reducing disaccharide.

In some embodiments the sweetener may comprise a reducing sugar. Without wishing to be bound by theory, it may be beneficial for the sweetener or combination of sweeteners added to the plant based milk to comprise a reducing sugar, to further enhance Maillard reaction flavours during the crumb formation step. In some embodiments the reducing sugar may comprise arabinose.

Without wishing to be bound by theory, it is thought that adding a suitable sweetening composition (i.e. a suitable sweetener or combination of sweeteners, such as a carbohydrate or combination of carbohydrates) to the plant-based milk, or to the crumb, promotes crystallisation during drying of the crumb and increases stability of the final confectionery product (i.e. the chocolate).

The reducing sugars generated in the plant-based milk/crumb of the invention may have different sweetness levels to the reducing sugars found in a dairy milk chocolate crumb/chocolate. For example, maltose is sweeter than the lactose found in milk (and hence present in standard dairy crumbs and chocolates). Therefore, in some embodiments the ingredients and their proportions in the sweetening composition are selected so as to achieve a suitable total carbohydrate content in the crumb, while balancing the sweetness of the resulting chocolate. For example, the sweetening composition may comprise a carbohydrate such as maltodextrin, which is generally not sweet in taste.

In preferred embodiments the sweetener added to the plant-based milk is, or comprises, sucrose.

In some embodiments the sweetener consists of sucrose.

In some embodiments the sweetener is added as a dry powder. In some embodiments the sweetener is added as a crystalline powder.

In some embodiments the sweetener, or sweetening composition, is added to the plant-based milk before the liquefaction step.

In some embodiments the sweetener, or sweetening composition, is added to the plant-based milk before the saccharification step.

In some embodiments the sweetener, or sweetening composition, is added to the plant-based milk after the liquefaction step.

In some embodiments the sweetener, or sweetening composition, is added to the plant-based milk after the saccharification step.

In some embodiments the sweetener, or sweetening composition, is added to the plant-based milk after crumb formation.

In preferred embodiments the sweetener, or sweetening composition, is added to the plant-based milk prior to crumb formation.

In some embodiments the sweetener, or sweetening composition, is added to the plant-based milk after the liquefaction and/or saccharification steps but prior to the crumb formation step.

More generally, sweeteners for addition to the plant-based milk, crumb or chocolate of the invention may be, or may comprise, a sugar as defined above or any other compound or mixture of compounds which affect the sweetness of the crumb or chocolate obtained by the process described herein. In some embodiments the sweetener can be a sugar (e.g. sucrose), a sugar alcohol (e.g. erythritol, maltitol, mannitol, sorbitol, xylitol, mannitol, lactitol, isomalt, or any combination thereof), intense sweeteners (e.g. aspartame, acesulfame potassium, cyclamates, saccharin, sucralose, neotame, neohesperidin, dihydrochalone, alitame, stevia sweeteners, rebaudioside, glycyrrhizin or any combinations thereof), dried fruit pulp extracts such as dehydrated extracts of cocoa fruit pulp, or any combination thereof.

In some embodiments, in addition to or instead of a sweetener, e.g. as part of a sweetening composition, a bulking ingredient such as inulin or fibre e.g. soluble corn fibre may be added to the plant-based milk, crumb or chocolate.

In some embodiments, the sweetening composition is added in an amount such that the total sweetener content of the resultant crumb, wherein the sweetener content includes any sweeteners (i.e. sugars, carbohydrates) originating from the plant-based milk as well as any added sweetener, is about 30-85% by weight. In some embodiments, the total sweetener content of the crumb is about 65-85% by weight. In some embodiments, the total sweetener content of the crumb is about 65-80% by weight. In some embodiments, the total sweetener content of the crumb is about 67-80% by weight. In some embodiments, the total sweetener content of the crumb is about 65-75% by weight. In some embodiments, the total sweetener content (or total sugars content) of the crumb is about 67-74% by weight.

In some embodiments, the sweetening composition is added in an amount such that the total combined sweetener and bulking ingredient content of the resultant crumb, wherein the sweetener and fibre content includes sugars originating from the plant-based milk as well as any added sweetener and bulking ingredient, is about 30-85% by weight. In some embodiments, combined sweetener and bulking ingredient content of the crumb is about 65-85% by weight. In some embodiments, combined sweetener and bulking ingredient content of the crumb is about 65-80% by weight. In some embodiments, combined sweetener and bulking ingredient content of the crumb is about 65-75% by weight. In some embodiments, combined sweetener and bulking ingredient content of the crumb is about 65-70% by weight. In some embodiments, combined sweetener and bulking ingredient content of the crumb is about 67% by weight.

In some embodiments, about 70-90% of the sweetener content in the final crumb consists of sugars (e.g. sucrose). In some embodiments, about 72-90% of the sweetener content in the final crumb consists of sugars (e.g. sucrose). In some embodiments, about 40-95% of the sweetener content in the final crumb consists of sugars (e.g. sucrose). In some embodiments, about 60-90% of the sweetener content in the final crumb consists of sugars (e.g. sucrose). In some embodiments, about 72-85% of the sweetener content in the final crumb consists of sugars (e.g. sucrose). In some embodiments, about 75-85% of the sweetener content in the final crumb consists of sugars (e.g. sucrose). In some embodiments, about 60-85% of the sweetener content in the final crumb consists of sugars (e.g. sucrose). In some embodiments, about 79-81% of the sweetener content in the final crumb consists of sugars (e.g. sucrose). In some embodiments, about 60-80% of the sweetener content in the final crumb consists of sugars (e.g. sucrose). In some embodiments, about 80% of the sweetener content in the final crumb consists of sugars (e.g. sucrose). In some embodiments, about 81% of the sweetener content in the final crumb consists of sugars (e.g. sucrose). In some embodiments, about 70-75% of the sweetener content in the final crumb consists of sugars (e.g. sucrose). In some embodiments, about 71% of the sweetener content in the final crumb consists of sugars (e.g. sucrose). In some embodiments, about 72% of the sweetener content in the final crumb consists of sugars (e.g. sucrose). In some embodiments, about 73% of the sweetener content in the final crumb consists of sugars (e.g. sucrose)

In some embodiments, the sweetening composition is added in an amount such that the total carbohydrate content of the resultant crumb, wherein the carbohydrate content includes carbohydrates originating from the plant-based milk as well as any added carbohydrate from the sweetening composition, is about 30-85% by weight.

In some embodiments, total carbohydrate content of the crumb is about 65-85%, based on the total weight of the crumb.

In some embodiments, the total carbohydrate content of the crumb is about 67-80% by weight.

In some embodiments, the total carbohydrate content of the crumb is about 67-78% by weight.

In some embodiments, the total carbohydrate content of the crumb is about 67-76% by weight.

In some embodiments, the total carbohydrate content of the crumb is about 69-80% by weight.

In some embodiments, the total carbohydrate content of the crumb is about 71-80% by weight.

In some embodiments, the total carbohydrate content of the crumb is about 73-80% by weight.

In some embodiments, the total carbohydrate content of the crumb is about 71-78% by weight.

In some embodiments, the total carbohydrate content of the crumb is about 73-78% by weight.

In some embodiments, the total carbohydrate content of the crumb is about 73-76% by weight.

In some embodiments, about 40-95% of the carbohydrate content in the final crumb consists of sugars (e.g. sucrose). In some embodiments, about 60-90% of the carbohydrate content in the final crumb consists of sugars (e.g. sucrose). In some embodiments, about 60-85% of the carbohydrate content in the final crumb consists of sugars (e.g. sucrose). In some embodiments, about 60-80% of the carbohydrate content in the final crumb consists of sugars (e.g. sucrose). In some embodiments, about 70-75% of the carbohydrate content in the final crumb consists of sugars (e.g. sucrose). In some embodiments, about 71% of the carbohydrate content in the final crumb consists of sugars (e.g. sucrose). In some embodiments, about 72% of the carbohydrate content in the final crumb consists of sugars (e.g. sucrose). In some embodiments, about 73% of the carbohydrate content in the final crumb consists of sugars (e.g. sucrose).

In some embodiments, the content of total sugars in the crumb is about 40-72% based on the total weight of the crumb. In some embodiments, the content of total sugars in the crumb is about 40-70% based on the total weight of the crumb. In some embodiments, the content of total sugars in the crumb is about 42-70% based on the total weight of the crumb. In some embodiments, the content of total sugars in the crumb is about 42-65% based on the total weight of the crumb. In some embodiments, the content of total sugars in the crumb is about 45-70% based on the total weight of the crumb. In some embodiments, the content of total sugars in the crumb is about 45-65% based on the total weight of the crumb. In some embodiments, the content of total sugars in the crumb is about 45-64% based on the total weight of the crumb.

In some embodiments, the sucrose content of the crumb is about 40-70% based on the total weight of the crumb. In some embodiments, the sucrose content of the crumb is about 42-60% based on the total weight of the crumb. In some embodiments, the sucrose content of the crumb is about 45-55% based on the total weight of the crumb. In some embodiments, the sucrose content of the crumb is about 53-60% based on the total weight of the crumb. In some embodiments, the sucrose content of the crumb is about 54% based on the total weight of the crumb. In some embodiments, the sucrose content of the crumb is about 50% based on the total weight of the crumb.

In some embodiments, the sweetening composition is added in an amount such that the total sweetener content of the resultant chocolate, wherein the sweetener content includes sweeteners (i.e. sugars, carbohydrates) originating from the plant-based milk as well as any added sweetener, is about 40-70% by weight. In some embodiments, the total sweetener content of the chocolate is about 55-60% by weight.

In some embodiments, the total carbohydrate content of the chocolate is about 50-70% by weight.

In some embodiments, the total carbohydrate content of the chocolate is about 50-65% by weight.

In some embodiments, the total carbohydrate content of the chocolate is about 50-60% by weight.

In some embodiments, the total carbohydrate content of the chocolate is about 55-70% by weight.

In some embodiments, the total carbohydrate content of the chocolate is about 55-65% by weight.

In some embodiments, the total carbohydrate content of the chocolate is about 55-60% by weight.

In some embodiments, the content of total sugars in the chocolate is about 30-60% based on the total weight of the chocolate. In some embodiments, the content of total sugars in the chocolate is about 30-55% by weight. In some embodiments, the content of total sugars in the chocolate is about 30-50% by weight. In some embodiments, the content of total sugars in the chocolate is about 34-50% by weight. In some embodiments, the content of total sugars in the chocolate is about 30-48% by weight. In some embodiments, the content of total sugars in the chocolate is about 34-48% by weight.

In some embodiments sweetening is performed after a liquefaction and/or saccharification step. In some embodiment sweetening is performed at the same time as a liquefaction and/or saccharification step. In some embodiments sweetening is performed at the same time as a saccharification step.

Without wishing to be bound by theory, it is thought that high levels of polysaccharides such as starch in plant-based milks may lead to the formation of viscous masses when these milks are heated above the gelatinisation temperature of the starch component. These viscous masses may produce undesirable textures and viscosities in the resulting crumbs and chocolates. This means that a process which is directly analogous to the traditional crumb process, wherein sweetened dairy milk (which does not contain starch) is simply concentrated by evaporation at elevated temperature, is not advisable with plant-based milks.

Accordingly, the process of the invention preferably comprises at least one liquefaction step.

In the liquefaction step, polysaccharides in the plant material are liquefied (i.e. partially broken down). In some embodiments polysaccharides in the plant material are liquefied by one or more enzymes. In some embodiments, liquefaction involves hydrolysis of the starch in the plant material. In some embodiments, liquefaction involves hydrolysis of the starch and 13-Glucans in the plant material. In some embodiments, liquefaction involves hydrolysis of glyosidic bonds between sugar monomer units in polysaccharides in the plant material. In some embodiments the polysaccharides are selected from starch, amylopectin, amylose, glycogen, cellulose, 13-Glucans or combinations thereof. In some embodiments the polysaccharides are selected from starch, 13-Glucans, cellulose or combinations thereof. In some embodiments the polysaccharides are selected from starch, 13-Glucans or combinations thereof. In some embodiments the polysaccharide is starch. In some embodiments the polysaccharide is 13-Glucan. Hydrolysis of the polysaccharides is preferably catalysed by an enzyme.

In some embodiments the liquefaction step comprises suspending particles of a plant material in water comprising one or more enzymes. In some embodiments the liquefaction step comprises treating a plant-based milk with one or more enzymes.

In some embodiments, the enzyme is a glycosidase. In some embodiments, the enzyme is a glucosidase. In some embodiments the enzyme is an amylase. In some embodiments the enzyme is a α-amylase. In some embodiments the α-amylase is derived from a bacterial source. In some embodiments the bacterial source of α-amylase is a bacteria of the Bacillus genus, including but not limited to Bacillus amyloliquefaciens, Bacillus licheniformis and Bacillus subtilis. In some embodiments the activity of the α-amylase is between 50,000 UB/g and 200,000 UB/g In some embodiments the activity of the α-amylase is between 100,000 UB/g and 500,000 UB/g In some embodiments the activity of the α-amylase is between 100,000 units/g and 500,000 units/g In some embodiments the activity of the α-amylase is between 200,000 units/g and 400,000 units/gin some embodiments the bacterial source of α-amylase is Bacillus licheniformis. In some embodiments the Bacillus licheniformis derived α-amylase has an activity of greater than 120,000 UB/g. In some embodiments the bacterial source of α-amylase is Bacillus subtilis. In some embodiments the Bacillus subtilis derived α-amylase has an activity of greater than 300,000 units/g (at 40° C.). Bacillus subtilis derived α-amylase advantageously has a high liquefaction activity and a low temperature threshold. This allows ready control of the extent of the starch hydrolysis performed on a plant material.

In some embodiments, the enzyme is a cellulase.

In some embodiments, the enzyme is a glucanase. In some embodiments the enzyme is a β-glucanase.

In some embodiments the fungal source of the β-glucanase is Aspergillus sp. In some embodiments the β-glucanase has an activity of between 100 nKat/g and 2000 nKat/g. In some embodiments the β-glucanase has an activity of between 500 nKat/g and 2000 nKat/g. In some embodiments the β-glucanase hasan activity of greater than 900 nKat/g.

In some embodiments polysaccharides in the plant material are liquefied using more than one enzymes. In some embodiments the plant material is liquefied using a combination of enzymes such as α-amylase and β-glucanase.

In some embodiments a crumb as described herein, i.e. obtained or obtainable by the process described herein, has a starch content of between about 0-10% starch. In some embodiments a crumb obtained or obtainable by the process described herein has a starch content of between 0-5% In some embodiments a crumb obtained or obtainable by the process described herein has a starch content of between 0.5-7% starch. In some embodiments a crumb obtained or obtainable by the process described herein has a starch content of between 0.5-2.5% In some embodiments a crumb obtained or obtainable by the process described herein has a starch content of between about 1-5% starch. In some embodiments a crumb obtained or obtainable by the process described herein has a starch content of between about 2-4% starch. In some embodiments a crumb obtained or obtainable by the process described herein has a starch content of between 1-2%. In some embodiments a crumb obtained or obtainable by the process described herein has a starch content of between 1.2-1.8%. In some embodiments a crumb obtained or obtainable by the process described herein has a starch content of between 1.4-1.7%. In some embodiments a crumb obtained or obtainable by the process described herein has a starch content of between 2-3% starch. In some embodiments a crumb obtained or obtainable by the process described herein has a starch content of between 4-8% starch. In some embodiments the liquefaction step comprises deactivated one or more enzymes when a certain degree of starch hydrolysis is achieved e.g. by heating the enzyme. In some alternate embodiments substantially all of the starch in the plant material is hydrolysed during the liquefaction step. The starch content and composition is determined by means of titration and enzymatic testing as accredited according to ISO 15914 (total starch), AOAC 2002.02 (resistant starch) and AACC 76-31 (damaged/gelatinised starch).

The composition of sugars following hydrolysis of starch is determined by means of IC-PAD testing as accredited according to standards UNE-EN ISO/IEC 17025:2017 ENAC 1094/LE2182, in addition to HPAEC-PAD testing according to standards ISO/CD 22184. Total carbohydrates content is determined by means of calculation, as accredited according to standards UNE-EN ISO/IEC 17025:2017 ENAC 1094/LE2182.

In some embodiments, additional starch, dextrins, syrup solids or maltodextrin can be added to a plant-based milk after the liquefaction step. Without wishing to be bound by theory, it is thought that adding some starch, dextrins, syrup solids or maltodextrins back into a plant-based milk may help lighten the colour of a chocolate product, and provide bulk to the crumb and/or chocolate without contributing taste, significant viscosity or sweetening. Preferably, starch, dextrins, syrup solids or maltodextrins may be added to a condensed plant-based milk.

In some embodiments the liquefaction step comprises adjusting and/or controlling the pH to between about 3 and about 9. In some embodiments the pH is between about 5 and about 8. In some embodiments the pH is between about 3 and about 7. In some embodiments the pH is between about 5 and about 9. In some preferred embodiments the pH is between about 5 and about 7. In some embodiments the pH is about 6. In some embodiments the pH is about 5.5.

In some embodiments the liquefaction step is performed at a calcium ion content (i.e. native or added calcium ions) of between about 50 and about 500 ppm. In some preferred embodiments the liquefaction step is performed at a calcium ion content of about 100 to 500 ppm. In some preferred embodiments the liquefaction step is performed at a calcium ion content of about 100 to 300 ppm. In some preferred embodiments the liquefaction step is performed at a calcium ion content of about 250 ppm. In some preferred embodiments the liquefaction step is performed at a calcium ion content of about 200 ppm. In some preferred embodiments the liquefaction step is performed at a calcium ion content of about 150 ppm. The calcium ion content can be determined by means of direct complexometric titration with ethylenediamine tetraacetate (EDTA).

In some embodiments the liquefaction step is comprises heating and/or maintaining the temperature between about 30° C. and 100° C.

In some embodiments the temperature is between about 50 to 75° C.,

In some embodiments the temperature is between about 85 to 90° C.,

In some embodiments the temperature is about 100° C.,

In some embodiments the liquefaction step comprises heating for between about 1 minute and about 5 hours. In some embodiments the liquefaction step comprises heating for up to about 1 hour. In some embodiments the liquefaction step comprises heating for between about 1 minute and about 5 hours.

In some embodiments, liquefaction comprises heating the plant material suspended in water in the presence of the enzyme as described herein, until the viscosity of the plant-based milk has sufficiently reduced.

In particular embodiments, the liquefaction step comprises heating between about 50-75° C., holding for about 10 to 20 minutes, then heating to a temperature of about 85 to about 90° C. for about 5 to about 25 minutes, followed by heating at about 100° C. for between about 1 and about 15 minutes.

In some embodiments, the process of the invention comprises at least one saccharification step.

In the saccharification step, reducing sugars are liberated from polysaccharides in the plant material, by hydrolysis of glyosidic bonds between the sugar monomer units of the polysaccharides. Hydrolysis of the polysaccharides is preferably catalysed by an enzyme. The polysaccharides may include starch, amylopectin, amylose, glycogen, cellulose, β-Glucans or combinations thereof. In some embodiments the reducing sugars are liberated from polysaccharides including starch in the plant material.

In some embodiments, the liberated reducing sugars (i.e. the reducing sugars produced by saccharification) comprise glucose and, maltose, in addition to other liberated carbohydrates including fructose, galactose, xylose, ribose, cellobiose, maltotriose, dextrins, maltodextrins, isomaltose, oligosaccharides, and any combination thereof.

In some embodiments the reducing sugars comprise reducing disaccharides. In some embodiments the reducing sugars comprise maltose and/or glucose. In preferred embodiments the reducing sugars comprise maltose.

The present inventors have discovered that it may be advantageous to perform at least one saccharification step to liberate higher quantities of reducing sugars, preferably reducing disaccharides such as maltose, in a plant-based milk because reducing sugars play a key role in Maillard reactions. Maillard reactions, which occur during the crumb formation process, are important to the flavour development of the crumbs and chocolates described herein.

Advantageously, the reducing sugars liberated in the saccharification step have reactive carbonyl groups which can react with the nucleophilic amino group of an amino acid via Maillard reactions, to create new flavour profiles. Preferably, the saccharification step liberates reducing sugars e.g. reducing disaccharides such as maltose from a polysaccharide. Like lactose, maltose also has a low sweetness relative to glucose. Maltose also inhibits the crystallisation of sugars such as sucrose less than does glucose. It is preferable for a crumb produced by the process described herein to have a high maltose to glucose ratio, as further described below.

In some cases, high levels of reducing sugars e.g. glucose and maltose may produce a retardation effect on the crystallization of non-reducing sugars such as sucrose in the crumbs and chocolate described herein and as such can lead to crumb and chocolate with an amorphous state. In some embodiments, it is therefore preferable for the crumbs of the invention to comprise no more than about 25% by weight of reducing sugars. In these embodiments, the levels of reducing sugars e.g. maltose and glucose in the plant-based milk should represent no more that 60% of the plant-based milks total dry weight, such that the subsequent plant-based crumbs contain no more than 25% reducing sugars.

Accordingly, in some embodiments, the plant-based milk for use in the crumb formation steps described herein (i.e. after liquefaction and/or saccharification) comprises no more than about 60% reducing sugars, based on the dry weight of the plant-based milk.

In some embodiments, the plant-based milk comprises no more than about 55% reducing sugars, based on the dry weight of the plant-based milk.

In some embodiments, the plant-based milk for use in crumb formation (i.e. after liquefaction and/or saccharification) comprises no more than about 50% reducing sugars, based on the dry weight of the plant-based milk.

In some embodiments, the plant-based milk comprises no more than about 45% reducing sugars, based on the dry weight of the plant-based milk.

In some embodiments, the plant-based milk comprises no more than about 40% reducing sugars, based on the dry weight of the plant-based milk.

In some embodiments, the plant-based milk comprises no more than about 30% reducing sugars, based on the dry weight of the plant-based milk.

In some embodiments, the plant-based milk comprises no more than about 20% reducing sugars, based on the dry weight of the plant-based milk.

In some embodiments, the plant-based milk for use in crumb formation (i.e. after liquefaction and/or saccharification) comprises at least 1% reducing sugars, based on the dry weight of the plant-based milk.

In some embodiments, the plant-based milk for use in crumb formation (i.e. after liquefaction and/or saccharification) comprises at least 3% reducing sugars, based on the dry weight of the plant-based milk.

In some embodiments, the plant-based milk for use in crumb formation (i.e. after liquefaction and/or saccharification) comprises at least 5% reducing sugars, based on the dry weight of the plant-based milk.

In some embodiments, the plant-based milk comprises at least 10% reducing sugars, based on the dry weight of the plant-based milk.

In some embodiments, the plant-based milk comprises at least 15% reducing sugars, based on the dry weight of the plant-based milk.

In some embodiments, a crumb as described herein (e.g. obtained or obtainable by the process described herein) preferably comprises no more than about 25% by weight of reducing sugars (e.g. glucose, fructose, galactose, xylose, ribose, glyceraldehyde, lactose, cellobiose, maltose, maltotriose, dextrins, arabinose or combinations thereof). In some embodiments it is preferable for the crumb to comprise no more than about 20% by weight of reducing sugars.

In some embodiments, a crumb as described herein (e.g. produced by the process described herein) preferably comprises no more than about 18% by weight of reducing sugars. In some embodiments, the crumb preferably comprises no more than about 15% by weight of reducing sugars. In some embodiments, the crumb preferably comprises no more than about 10% by weight of reducing sugars. In some embodiments, the crumb preferably comprises no more than about 8% by weight of reducing sugars. In some embodiments, the crumb preferably comprises no more than about 7% by weight of reducing sugars.

In some embodiments, a crumb as described herein (e.g. produced by the process described herein) preferably comprises no more than about 20% maltose and glucose (combined weight) based on the total weight of the crumb. In some embodiments, the crumb preferably comprises about 1% to about 15% maltose and glucose. In some embodiments, the crumb preferably comprises about 1% to about 10% maltose and glucose. In some embodiments, the crumb preferably comprises about 1% to about 8% maltose and glucose. In some embodiments, the preferably comprises about 1.5% to about 7% maltose and glucose. In some embodiments, the crumb preferably comprises about 1.7% to about 6.8% maltose and glucose

In some embodiments it is preferable for the crumb to comprise no more than about 20% by weight of reducing disaccharides (e.g. maltose). In some embodiments it is preferable for a crumb as described herein (e.g. obtained or obtainable by the process described herein) to comprise up to about 20% by weight of maltose. In some embodiments the crumb comprises between about 5% and about 20% by weight of maltose. In some embodiments the crumb comprises between about 5% and about 17% by weight of maltose. In some embodiments the crumb comprises between about 5% and about 20% by weight of maltose. In some embodiments the crumb comprises between about 8% and about 14% by weight of maltose. In some embodiments the crumb comprises between about 5% and about 10% by weight of maltose. In some embodiments the crumb comprises between about 5% and about 7% by weight of maltose.

Maltose is a reducing disaccharide and so has a reactive carbonyl group which can react with the nucleophilic amino group of an amino acid during the Maillard reaction, to create new flavour profiles. Chocolates produced using a plant-based crumb as described herein, e.g. comprising reducing disaccharides at the disclosed levels, will have the delicious, complex flavour profile associated with dairy milk chocolates formed using a crumb method, because a high proportion of Maillard reactions can occur.

Also, like the lactose found in dairy milks, maltose has a low sweetness relative to glucose. Maltose also inhibits the crystallisation of sugars (e.g. sucrose) less than does glucose.

In some embodiments it is therefore preferable for the plant-based milk (after liquefaction and/or saccharification) to have a relatively high maltose content. In some embodiments it is preferable for the plant-based milk, after liquefaction and/or saccharification, to have a high maltose to glucose ratio.

In some embodiments the ratio of glucose to maltose in the crumb is between about 1:0.1 and 1:50 on a dry weight basis. In some embodiments the ratio of glucose to maltose in the plant-based milk (after liquefaction and/or saccharification) is between about 1:1 and 1:50 on a dry weight basis. In some embodiments the ratio of glucose to maltose in the plant-based milk (after liquefaction and/or saccharification) is between about 1:5 and 1:25 on a dry weight basis. In some embodiments the ratio of glucose to maltose in the plant-based milk (after liquefaction and/or saccharification) is about 1:25 on a dry weight basis. In some embodiments the ratio of glucose to maltose in the plant-based milk (after liquefaction and/or saccharification) is about 1:20 on a dry weight basis. In some embodiments the ratio of glucose to maltose in the plant-based milk (after liquefaction and/or saccharification) is about 1:15 on a dry weight basis. In some embodiments the ratio of glucose to maltose in the plant-based milk (after liquefaction and/or saccharification) is about 1:10 on a dry weight basis. In some embodiments the ratio of glucose to maltose for the plant-based milk (after liquefaction and/or saccharification) is about 1:5 on a dry weight basis.

In some embodiments the ratio of glucose to maltose in the crumb is between about 1:0.1 and 1:50 on a dry weight basis. In some embodiments the ratio of glucose to maltose in the crumb is between about 1:1 and 1:50 on a dry weight basis. In some embodiments the ratio of glucose to maltose in the crumb is between about 1:5 and 1:25 on a dry weight basis. In some embodiments the ratio of glucose to maltose in the crumb is about 1:25 on a dry weight basis. In some embodiments the ratio of glucose to maltose in the crumb is about 1:20 on a dry weight basis. In some embodiments the ratio of glucose to maltose in the crumb is about 1:15 on a dry weight basis. In some embodiments the ratio of glucose to maltose in the crumb is about 1:10 on a dry weight basis. In some embodiments the ratio of glucose to maltose in the crumb is about 1:5 on a dry weight basis.

Composition of sugars can be determined by means of IC-PAD testing as accredited according to standards UNE-EN ISO/IEC 17025:2017 ENAC 1094/LE2182, in addition to HPAEC-PAD testing according to standards ISO/CD 22184.

In some embodiments, in the saccharification step, reducing sugars are liberated from a plant material by one or more enzymes.

In some embodiments the saccharification step comprises suspending particles of a plant material in water comprising one or more enzymes.

In some embodiments, the saccharification step comprises treating the plant-based milk with one or more enzymes.

In some embodiments, the enzyme is a glycosidase enzyme. In some embodiments, the enzyme is a glucosidase. In some embodiments the enzyme comprises one or more amylase enzymes. In some embodiments the enzyme is a α-amylase. In some embodiments the α-amylase has an activity of between 5,000 SKB/g and 50,000 SKB/g. In some embodiments the α-amylase has an activity of between 10,000 SKB/g and 40,000 SKB/g In some embodiments the α-amylase can be derived from a fungal source. In some embodiments the fungal source of α-amylase is selected from the group of Aspergillus oryzae or Aspergillus niger. In some preferred embodiments the fungal source of α-amylase is Aspergillus oryzae. In some embodiments the Aspergillus oryzae derived α-amylase has an activity of greater than 30,000 SKB/g.

In some embodiments the enzyme is a β-amylase. In some embodiments the enzyme can be derived from Bacillus cereus or plant sources such as sweet potato (Ipomoea batatas), barley (Hordeum vulgare) or combinations thereof.

The benefit of using an α-amylase derived from a fungal source or a β-amylase enzyme in the saccharification step is that these enzymes allow a high yield of reducing sugars (e.g. maltose) to be liberated from the plant material. In some embodiments the β-amylase may be native to a plant material used in the plant-based milks e.g. sweet potato can possess a high level of native β-amylase. In some embodiments the β-amylase may be added to the plant-based milk. In some embodiments some β-amylase may be native to a plant material and some β-amylase may be added.

In some embodiments the β-amylase has an activity of about 100000 units/ml to about 1000000 units/ml.

In some embodiments the β-amylase has an activity of about 700000 units/ml.

In some embodiments the saccharification step comprises adjusting and/or maintaining the pH at between about 3 and about 9. In some embodiments the pH is between about 4 and about 7. In some embodiments pH is between about 3 and about 7. In some embodiments the pH is between about 4 and about 9. In some embodiments the pH is between about 3 and about 6. In some embodiments the pH is between about 4 and about 5. In some embodiments the pH is about 4.8. In some preferred embodiments the pH is between about 5 and about 6. In some embodiments the pH is between about 5.3 and about 5.8. In some embodiments the pH is about 5.5.

In some embodiments the saccharification comprises heating to and/or maintaining a temperature of between about 10° C. and about 100° C. In some embodiments the temperature is between about 15° C. and about 30° C. In some embodiments the temperature is between about 10° C. and about 30° C. In some embodiments the temperature is between about 15° C. and about 100° C. In some embodiments the temperature is about 20° C. In some embodiments the temperature is between about 45° C. and about 55° C. In some embodiments the temperature is between about 55° C. and about 65° C.

In some embodiments the saccharification step comprises heating for between about 15 minutes and about 5 hours. In some embodiments the saccharification step comprises heating for between 30 minutes and 3 hours.

In a particular embodiment, a liquefied plant-based milk is subjected to a saccharification step as described herein, designed to liberate maltose. A α-amylase that is derived from Aspergillus oryzae is added to the plant-based milk, at a temperature between 45 to 55° C. and the pH is adjusted where necessary to between 4-7. The suspension is then incubated to a temperature of between 45 to 65° C., for a period preferably within the range of 30 minutes to 3 hours depending on the degree of saccharification required.

In another particular embodiment, a liquefied plant-based milk is subjected to a saccharification step as described herein, designed to liberate maltose. The plant-based milk following a liquefaction step is cooled (or heated, as necessary) to a temperature of 55 to 60° C. and a β-amylase (of bacterial or vegetable origin) is added at an adjusted pH of between 5.3-5.8, and incubated to a temperature of between 55 to 60° C. for a period preferably within the range of about 30 minutes to three hours depending on the plant-based milks concentration of starch, and activity of the enzyme, whereby β-amylase with an activity of 700,000u/ml, approximately one β-amylase unit is required to convert 1.10% starch solutions at 60° C., pH 5.5 to maltose every hour.

In some embodiments a saccharification step is performed but a liquefaction step is not performed.

In some embodiments a liquefaction step is performed but a saccharification step is not performed.

In some embodiments the liquefaction step is performed at the same time as the saccharification step.

In some embodiments the liquefaction step is performed prior to the saccharification step.

In some embodiments the saccharification step is performed prior to the liquefaction step.

Without wishing to be bound by theory, it is thought that, in some embodiments, it can be advantageous to perform a saccharification step prior to a liquefaction step, to help limit the amount of reducing sugars liberated during a saccharification step, thereby increasing the yield and proportion of partially hydrolysed starch, for example in the form of neutral flavoured dextrins or soluble fibres to assist in the reduction of the overall sweetness of the crumb, and can be produced by the process described herein.

In some embodiments, it may be possible or preferable to perform a liquefaction step only, and not to perform a saccharification step. For example, if the plant material already comprises sufficient levels of reducing sugars, or if sufficient levels of reducing sugars are present in the plant-based milk after a liquefaction step alone.

In some embodiments a plant material on which a liquefaction and/or saccharification step has been performed may be available e.g. commercially. Provided that the levels of reducing sugars are suitable, the plant material thus processed may be suspended in water, optionally with the addition of a sweetener (i.e. carbohydrate) as described herein, to form a plant-based milk suitable for use in the invention; crumb formation steps may then be carried out, as described herein.

Accordingly, a further aspect of the present invention is a process for producing a crumb based on a plant-based milk, wherein the plant-based milk comprises an aqueous suspension of plant material, said plant material having been subjected to at least one treatment step selected from: liquefaction, saccharification, or hydrolysis; wherein the process comprises one or more crumb formation steps, as further described below.

When liquefaction and/or saccharification steps, as described herein, have been performed on a plant material, and the plant material has been processed into a plant-based milk, the plant-based milk is suitable for the production of a chocolate crumb.

Without wishing to be bound by theory, depending on the type and origin of the enzymes used, their biological activity, and the overall composition of the plant-based milk, including the balance of amylose and amylopectin, the liquefaction and/or saccharification steps may transform a resulting plant-based milk's carbohydrate structure and balance of sugars. In the process described herein, sugars e.g. reducing sugars such as maltose are available to participate in Maillard reactions during the crumb formation steps. Maillard reactions give the crumbs and chocolates described herein the complex flavours typically associated with traditional crumb processes. The superior complex flavour profile of the crumbs/chocolates produced using the crumb process of the current invention cannot be produced by mixing dry ingredients to produce a plant-based chocolate, as is customary in the art.

The process of the invention includes at least one crumb formation step, wherein at least one plant-based milk (e.g. a plant-based milk treated as described above) is heated and dried, to form a crumb. During the crumb formation step a high proportion of Maillard reactions are able to occur, leading to the production of a crumb which can be used to produce a delicious-tasting chocolate with a complex flavour profile.

In preferred embodiments, crumb formation may comprise:
evaporation to form a condensed plant-based milk;
optionally, adding cocoa solids to the condensed plant-based milk;
heating the condensed plant-based milk;
drying the condensed plant-based milk, preferably to a moisture content below about 5%, more preferably to a final moisture content of about 1-3%.

In some embodiments, following liquefaction, saccharification, and/or optional further steps as described above, a plant-based milk is concentrated by boiling off the water content, for example in a vessel capable of heating and agitating (e.g. through use of scrapers) the highly-viscous suspension, preferably under reduced atmospheric pressure (partial vacuum).

In some embodiments, prior to evaporation, a food grade anti-foaming agent is added to the plant-based milk for use as a processing aid.

Anti-foaming agents (anti-foams) are known in the art, and may serve to hinder the formation of foam during the cooking and evaporation process. Anti-foaming agents include, but are not limited to, silicone based additives.

In some embodiments cocoa butter can be used as an antifoaming agent. The amount of cocoa butter to be added may be determined and/or adjusted, for example in order to achieve a suitable fat content for the resultant crumb or chocolate, as is described herein.

In some embodiments, crumb formation comprises a step wherein the plant-based milk, as described herein, is evaporated to form a condensed plant-based milk.

In some embodiments the evaporation step comprises evaporating the plant-based milk to form a condensed plant-based milk with a solids content of between about 70% and about 95% by weight. In some embodiments evaporation comprises evaporating the plant-based milk to form a condensed plant-based milk with a solid content between about 80% and about 90% by weight. In some embodiments, in particular in processes for the production of a chocolate crumb, evaporation comprises evaporating the plant-based milk to form a condensed plant-based milk with a solid content of about 88% by weight. In alternative embodiments, in particular in processes for the production of a white crumb, the evaporation step comprises evaporating the plant-based milk to form a condensed plant-based milk with a solid content of about 90% weight.

The total solids content may be determined by means of calculation on the basis of the moisture content on a percentage weight basis. Moisture content of the crumb is determined by means of gravimetric testing as accredited according to standards UNE-EN ISO/IEC 17025:2017 ENAC 1094/LE2182. Thereafter, practitioners skilled in the art of the crumb process can begin to recognise the approximate solids content of the condensed plant-based milk by monitoring the pressure and subsequent boiling temperature of the plant based milk, or by measuring the brix value (dissolved sugars) using a refractometer and calibrating those value to the total solids content.

In some embodiments the ratio of glucose to maltose in the condensed plant-based milk is between about 1:0.1 and 1:50 on a dry weight basis. In some embodiments the ratio of glucose to maltose in the condensed plant-based milk is between about 1:1 and 1:50 on a dry weight basis. In some embodiments the ratio of glucose to maltose in the condensed plant-based milk is between about 1:5 and 1:25 on a dry weight basis. In some embodiments the ratio of glucose to maltose in the condensed plant-based milk is about 1:25 on a dry weight basis. In some embodiments the ratio of glucose to maltose in the condensed plant-based milk is about 1:20 on a dry weight basis. In some embodiments the ratio of glucose to maltose in the condensed plant-based milk is about 1:15 on a dry weight basis. In some embodiments the ratio of glucose to maltose in the condensed plant-based milk is about 1:10 on a dry weight basis. In some embodiments the ratio of glucose to maltose for condensed plant-based milk is about 1:5 on a dry weight basis.

In some embodiments, cocoa solids are added to the condensed plant-based milk described herein. In some embodiments cocoa solids are added to the condensed plant-based milk until the condensed plant-based milk has a total solids content of between about 80% and about 95%. In some embodiments cocoa solids are added to the condensed plant-based milk until the condensed plant-based milk has a total solids content of about 90%.

In some embodiments the cocoa solids comprise cocoa liquor, cocoa nibs, cocoa powder, cocoa fibre or combinations thereof.

In some embodiments a plant-based chocolate crumb produced by a process as described herein can comprise between about 1% and about 20% by weight dry non-fat cocoa solids. In some embodiments the chocolate crumb may comprise between about 5% and about 10% by weight dry non-fat cocoa solids.

In some embodiments the chocolate crumb may comprise about 7% by weight dry non-fat cocoa solids.

In some embodiments the chocolate crumb comprises between about 3 and about 8% by weight of dry non-fat cocoa solids. In some embodiments the chocolate crumb comprises about 6% by weight of dry non-fat cocoa solids.

In some embodiments, inclusion of cocoa liquor may be the preferred choice for the production of a plant-based chocolate crumb. In some embodiments, the cocoa liquor represents approximately 10-15% of the total dry weight of the crumb. In particular embodiments, the cocoa liquor represents preferably about 12.25 to 13.25% of the total dry weight of the crumb, with the dry non-fat cocoa solids equivalent preferably representing approximately 6% of the final crumb weight.

In some embodiments water is evaporated from the plant-based milk at atmospheric pressure (e.g. by heating at atmospheric pressure). In some embodiments liquid is evaporated from the plant-based milk under reduced atmospheric pressure. In some embodiments liquid is evaporated from the plant-based milk by heating under reduced atmospheric pressure.

In some embodiments evaporation is carried out at a reduced pressure. In some embodiments evaporation is carried out at a reduced pressure of between about 10 and about 1000 millibar. In some embodiments evaporation is carried out at a reduced pressure of between about 100 and about 500 millibar. In some embodiments evaporation is carried out at a reduced pressure of between about 200 and about 400 millibar.

The condensed plant-based milk is preferably heated during and/or after evaporation.

In some embodiments evaporation is carried out at a temperature of between about 30° C. and about 100° C. In some embodiments evaporation is carried out at a temperature of between about 50° C. and about 90° C. In some embodiments evaporation is carried out at a temperature of at least about 60° C. In some embodiments evaporation is carried out at a temperature of between about 60° C. and about 100° C. In some embodiments evaporation is carried out at a temperature of between about 60° C. and about 90° C.

In some embodiments, the plant-based milk is agitated during evaporation and/or heating.

In some embodiments of the process of the invention crumb formation comprises a heating step. In some embodiments the heating step comprises heating a condensed plant-based milk in the presence or absence of cocoa solids.

In some embodiments the condensed plant-based milk is heated at between about 50° C. and about 100° C. In some embodiments the condensed plant-based milk is heated at between about 80° C. and about 90° C. In some embodiments the condensed plant-based milk is heated at between about 90° C. and about 100° C. In some embodiments the plant-based milk is heated in a tray. In some embodiments heating performed under reduced pressure. In some embodiments heating performed under reduced pressure. In some embodiments heating is performed under a reduced pressure of between about 10 and about 1000 millibar. In some embodiments heating is performed under a reduced pressure of between about 10 and about 200 millibar. In some embodiments heating is performed under a reduced pressure of between about 50 and about 1000 millibar. In some embodiments heating is performed under a reduced pressure of between about 50 and about 100 millibar. In some embodiments the condensed plant-based milk is heated at about 80° C. to about 90° C. for about 1 hour under a reduced pressure of about 100 millibar followed by heating at about 90° C. to about 100° C. for about 1 hour or more to produce a crumb. In some embodiments the condensed plant-based milk is heated for about 10 mins to about 24 hours. In some embodiments the condensed plant-based milk is heated for about 30 mins to about 5 hours. In some embodiments the condensed plant-based milk is heated in either a vacuum dryer, a vacuum banded dryer, a vacuum roller dryer, a vacuum scraped surface heat exchanger or a specialised vacuum drying kneader reactor.

In some embodiments the condensed plant-based milk is kneaded. In some embodiments kneading is conducted at a temperature of between about 10° C. and about 100° C. In some embodiments kneading is conducted at a temperature of between about 10° C. and about 80° C. In some embodiments kneading is conducted at a temperature of between about 60° C. and about 100° C. In some embodiments kneading is conducted at a temperature of between about 60° C. and about 80° C. It may be advantageous to knead the condensed plant-based milk as it is thought that kneading may promote the crystallisation and stiffening of the condensed plant-based milk into a crumb.

In a particular embodiment, a sweetened plant-based milk, as described herein, is placed in a vessel capable of heating and agitating (through use of scrapers) the highly viscous suspension under reduced atmospheric pressure (partial vacuum) and may first be treated with an anti-foam, preferably a silicone based additive, to hinder the formation of foam during the cooking and evaporation process. After which, it may gradually be heated to a temperature of approximately 60° C. under a reduced atmosphere of between 800-200 millibars of pressure, whilst being stirred to prevent product build up on the heated surfaces of the vessel throughout the evaporation process. As the water vapour boil-off continues, the atmospheric pressure within the vessel may gradually be reduced further, e.g. to 100 millibar and the product temperature may be increased to approximately 69° C., or until such temperature that the resulting condensed plant-based milk has a total solids content of approximately 88%. At this point the vessel's vacuum pump may be turned off and the condensed plant-based milk may be discharged into a heavy duty, heated mixer capable of slowly kneading the thick paste at either atmospheric or reduced atmospheric pressure, and heating the mixture to a temperature of between 60-80° C.

In this embodiment, for the production of a plant-based chocolate crumb, cocoa liquor (which may be derived from fermented or unfermented cocoa), or alternatively cocoa nibs, cocoa powder or cocoa fibre may be added to the condensed plant-based milk, which will increase the total solids content of the mixture, resulting in a thick paste with a total solids content of approximately 90%. This mixture is then slowly kneaded and heated to a temperature of 60-80° C. at standard atmospheric pressure (1,013 mbar) for a period of between 5-15 minutes, to promote crystallisation of paste sugars and stiffening of the paste.

Alternatively in this embodiment, for the production of a plant-based white crumb, inclusion of cocoa liquor, cocoa nibs, cocoa powder or cocoa fibre is omitted and the proportion of total solid is increased by means of continued evaporation by heating and kneading the mixture under a reduced atmospheric pressure of 50 millibar at a temperature of 60-90° C. for 5-15 minutes or until such time that the total solids content of the mixture equals approximately 90%.

In some embodiments crumb formation comprises a final drying step. In some embodiments, final drying can also be carried out on a continuous basis following the hearing and/or evaporation steps, for example using a vacuum banded dryer, vacuum roller dryer or vacuum scraped surface heat exchanger and specialised vacuum drying kneader reactor.

In some embodiments the drying step comprises drying a condensed plant-based milk to produce a crumb.

The condensed plant-based milk is preferably heated during the drying step. Without wishing to be bound by theory, elevated temperatures are necessary for the desirable Maillard reactions to occur and hence for the complex flavour typically associated with traditional crumb processes to be obtained.

Drying preferably comprises heating the condensed plant-based milk, preferably at reduced pressure.

In some embodiments drying is carried out at a temperature of at least about 80° C.

In some embodiments drying is carried out at a temperature of at least about 85° C.

In some embodiments drying is carried out at a temperature of at least about 90° C.

In some embodiments drying is carried out at a temperature of at least about 100° C.

In some embodiments, drying comprises heating to a temperature of about 80-150° C.

In some embodiments, drying comprises heating to a temperature between about 85° C. and about 150° C.

In some embodiments, drying comprises heating to a temperature between about 90° C. and about 150° C.

In some embodiments drying is carried out at a temperature of between about 100-150° C.

In some embodiments, drying comprises heating to a temperature between about 80° C. and about 145° C.

In some embodiments, drying comprises heating to a temperature between about 90° C. and about 145° C.

In some embodiments, drying comprises heating to a temperature between about 100° C. and about 145° C.

In some embodiments drying is carried out at a temperature of between about 80° C. and about 90° C.

In some embodiments, drying is carried out at a reduced pressure.

In some embodiments, drying is carried out at a reduced pressure of about 50 millibar.

In some embodiments drying is carried out at a reduce pressure of about 25 millibar.

In some embodiments, drying is carried out at a reduced pressure of about 50 millibar for at least two hours. In some embodiments, drying is carried out at a reduced pressure of about 50 millibar and a temperature of between 80 and 150° C.

In some embodiments, drying comprises heating for at least about 30 mins. In some embodiments, drying comprises heating for at least about 1 hour.

In some embodiments, drying comprises heating for between 1 and 8 hours

In some embodiments the drying step comprises drying the plant-based milk to a moisture content below about 5%. In some embodiments the drying step comprises drying the plant-based milk to a moisture content below about 4%. In some embodiments the drying step comprises drying the plant-based milk to a moisture content below about 3%. In some embodiments the process of the invention comprises drying the plant-based milk to a moisture content of between 1% and 3%. In some embodiments the process of the invention comprises drying the plant-based milk to a moisture content of about 2%. Moisture content of the crumb may be determined by means of gravimetric testing as accredited according to standards UNE-EN ISO/IEC 17025:2017 ENAC 1094/LE2182.

In a particular embodiment, following evaporation, heating and kneading as described above, a condensed plant-based milk as described herein (with or without added cocoa solids), having a total solids content of approximately 90%, is loaded into trays at a thickness of approximately 2-5 cm deep and transferred in batches to a vacuum dryer with heated shelves, where the shelves are heated to between 80-150° C., under a reduced atmospheric pressure of approximately 100 millibar, for approximately one hour. After which, the atmospheric pressure is reduces to approximately 50 millibar and the shelves are heated to 90-150° C. for approximately 1 more hour, or until such time that the total moisture content of the paste is reduced to approximately 1-3% of the total weight of the crumb, at which point the product is described as a crumb. Once the moisture content of the crumb has been reduced to 1-3%, the product is removed from the vacuum dryer, broken with a hammer or similar lump breaker equipment, and stored in an airtight container until such time that it is needed for the production of dairy-free alternatives to milk chocolate and white chocolate.

Also provided herein is a process for producing a plant-based chocolate. In some embodiments, the process comprises:
providing at least one plant-based crumb (i.e. a crumb based on a plant-based milk); and mixing said crumb with a fat.

In some embodiments, the process comprises:
producing at least one plant-based crumb by a process as described above; and mixing said crumb with a fat.

In some embodiments, one or more different plant based crumbs may be combined, before mixing the resultant combined plant-based crumb with said fat.

In some embodiments the process further comprises grinding the crumb to a particle size of less than 500 microns. In some embodiments the process further comprises grinding the crumb to a particle size of less than 300 microns. In some embodiments the process further comprises grinding the crumb to a particle size of less than 200 microns.

In some embodiments the chocolate is a dairy-free chocolate. In some embodiments the chocolate is a dairy-free milk chocolate (i.e. a dairy-free alternative to milk chocolate). In some embodiments the chocolate is a dairy-free white chocolate (i.e. a dairy-free alternative to white chocolate). In some embodiments the chocolate is a vegan chocolate. In some embodiments the chocolate is a vegan milk chocolate (i.e. a vegan alternative to milk chocolate). In some embodiments the chocolate is a vegan white chocolate (i.e. a vegan alternative to white chocolate).

In some embodiments the fat is a vegetable fat. In some embodiments fat comprises cocoa butter and/or cocoa butter alternatives e.g. (cocoa butter substitute (CBS), cocoa butter replacer (CBR), cocoa butter extender (CBE) or other cocoa butter alternatives). Such products are well known in the art of confectionery and are commercially available from a variety of sources, e.g. non-lauric and lauric substitutes made from vegetable fats.

The amount of fat mixed with the chocolate crumb may vary depending on the desired characteristics for a chocolate. In some embodiments total fat makes up between about 20% and about 60% by weight of the chocolate obtained or obtainable by the process described herein. In some embodiments fat makes up between about 20% and about 45% by weight of the chocolate obtained or obtainable by the process described herein. In some embodiments the total fat content of the chocolate obtained or obtainable by the process described herein is between about 31% and 42%. In some embodiments the total fat content of the chocolate obtained or obtainable by the process described herein is at least about 25%. In some embodiments the total fat content of the chocolate obtained or obtainable by the process described herein is at least about 30%. In some embodiments the total fat content of the chocolate obtained or obtainable by the process described herein is at least about 31%. In some embodiments the total fat content of the chocolate obtained or obtainable by the process described herein is at least about 35%.

In some embodiments the processes of the invention further comprises mixing the chocolate crumb with an emulsifier. In some embodiments the emulsifier comprises sunflower lecithin, soya lecithin or combinations thereof. In some embodiments the emulsifier makes up between about 0% and about 5% by weight of the chocolate obtained or obtainable by the process described herein.

In some embodiments the process of the invention further comprises mixing the chocolate crumb with additives e.g. to improve or modify the flavour of a chocolate. In some embodiments the additives comprise vanilla flavouring, such as dried vanilla powder.

In some embodiments the process for making chocolate further comprise the steps of refining, for example to a particle size of between 25 and 15 microns, followed by conching and tempering the chocolate.

Steps available for the processing of the chocolates described herein are broadly analogous to those available for conventional (i.e. dairy-based) chocolates, and as such are known to the relevant person skilled in the art.

Certain embodiments of the present invention may be characterised by the following numbered statements:
One. A process for producing a crumb based on a plant-based milk, wherein said plant-based milk comprises an aqueous suspension of plant material, the process comprising the steps of:
   a. liquefaction, wherein polysaccharides in the plant material are liquefied by one or more enzymes;
   b. saccharification, wherein reducing sugars are liberated from the plant material by one or more enzymes; and
   c. crumb formation, wherein the plant-based milk is heated and dried to a crumb.
Two. The process of statement one, wherein the saccharification step comprises suspending particles of a plant material in water comprising one or more enzymes;
   or treating the plant-based milk with one or more enzymes;
   and/or wherein the liquefaction step comprises suspending particles of a plant material in water comprising one or more enzymes;
   or treating the plant-based milk with one or more enzymes.
Three. The process of any one of the preceding statements, wherein the process further comprises at least one protein adjustment step, wherein protein adjustment comprises:
   a. protein hydrolysis, wherein the plant-based milk is treated with a proteolytic enzyme; or
   b. addition of protein hydrolysates;
   preferably, wherein the proteolytic enzyme is selected from papain or a carboxypeptidase and/or wherein the protein hydrolysates are selected from soya, pea or hemp protein hydrolysates.
Four. The process of any one of the preceding statements wherein the process further comprises the addition of sweetener such as sucrose;
   preferably, wherein sucrose is added in an amount such that the total sweetener content of the crumb is between about 30 and 85% of the weight of the dried crumb, more preferably the total sweetener content of the crumb is about 65-75%;
   preferably, wherein the sweetener such as sucrose is added to the plant-based milk before the crumb formation step, and optionally after the liquefaction and/or saccharification steps.
Five. The process of any one of the preceding statements wherein the process further comprises at least one defatting step, wherein the fat content of the plant-based milk is reduced to no more than 30% by weight on a dry weight basis.
Six. The process of any one of the preceding statements, wherein liquefaction is effected by one or more amylase enzymes and/or glucanase enzymes,
   wherein the amylase enzyme is preferably a fungal α-amylase, or a β-amylase,
   and/or wherein the glucanase enzyme is preferably a fungal β-glucanase;
   and/or wherein saccharification is effected by one or more α-amylase enzymes, wherein the amylase enzyme is preferably a bacterial α-amylase;
   and/or wherein the reducing sugars comprise reducing disaccharides such as maltose.
Seven. The process of any one of the preceding statements, wherein crumb formation comprises:
   a. evaporation to form a condensed plant-based milk;
   b. optionally, adding cocoa solids to the condensed plant-based milk;
   c. heating the condensed plant-based milk;
   d. drying the condensed plant-based milk, preferably to a moisture content below about 5%, more preferably to a final moisture content of about 1-3%.
Eight. The process of statement seven, further comprising addition of an anti-foaming agent prior to the evaporation step;
   and/or wherein evaporation is carried out at reduced pressure;
   and/or wherein evaporation is carried out at a temperature of at least about 60° C.;
   and/or wherein the condensed plant-based milk has a total solids content of about 80 to 95%,
   optionally including any cocoa solids added after evaporation;
   and/or wherein the cocoa solids are selected from cocoa liquor, cocoa nibs, cocoa powder or cocoa fibre.
Nine. The process of any one of statements seven or eight, wherein heating the condensed plant-based milk comprises kneading the condensed plant-based milk at a temperature of about 60 to 80° C.; preferably, wherein heating the condensed plant-based milk comprises kneading the condensed plant-based milk at a temperature of about 60 to 90° C., more preferably at reduced pressure; preferably, wherein the kneading and heating step is carried out for about 5 to 15 minutes; preferably, wherein the drying step is carried out by heating the condensed plant-based milk to a temperature of about 80 to 150° C., more preferably under vacuum.
Ten. The process of any one of the preceding statements wherein the crumb has a final total moisture content of about 1-3%;
   and/or wherein the crumb has a final total sugar content of about 67-74% by weight;
   and/or wherein the crumb has a total protein content of about 3-10% of the weight of the dried crumb;
   and/or wherein the crumb has a fat content of about 15% by weight.
Eleven. The process according to any one of the preceding statements, wherein the plant-based milk is an aqueous suspension derived from at least one plant material, selected from cereals, tubers, pseudocereals, legumes, oil seeds, nuts, and combinations thereof;
   preferably, wherein the plant material is derived from tiger nuts, sweet potato, rice, oats, amaranth, teff, sorghum, quinoa, buckwheat or combinations thereof;
   more preferably, wherein the plant material further comprises an adjunct plant material selected from hazelnuts, peanuts, cashew nuts, macadamia nuts, coconut, almond, chickpea, pea, soya, hemp seed, sunflower seeds, sesame seeds and combinations thereof;
   and/or wherein the plant-based milk is formed by suspending particles of a plant material in water.
Twelve. A plant-based crumb obtained or obtainable by the process of any of statements one to eleven.
Thirteen. Use of a plant-based crumb according to statement twelve, for the production of a plant-based chocolate or chocolate product.
Fourteen. A process for producing a plant-based chocolate comprising:
   a. producing a crumb by the process of any one of statements one to eleven; and
   b. mixing the crumb with a fat;
   preferably, wherein the fat is a vegetable fat, more preferably wherein the fat is selected from cocoa butter, cocoa butter substitute, cocoa butter replacer, cocoa butter extender and combinations thereof;
   preferably, the process further comprises grinding the crumb to a particle size of less than 300 microns.
   preferably, the process further comprising the steps of refining, conching and/or tempering of the chocolate.
Fifteen. A plant-based chocolate obtained or obtainable by the process of statement fourteen.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### EXAMPLES

### Example 1

A vegan crumb, for use in the production of a dairy-free alternative to milk chocolate was prepared in the following way.

1300 g of tiger nut were partially defatted, if required, to a fat content of around 12% with the use of a preheated oil screw press. The tiger nut meal was then ground into a fine flour using a dry mill (spice grinder). 216 g of raw hazelnuts were placed on a tray and roasted in an oven at 140° C. for 20 min, then cooled and ground into a fine flour using a dry mill (spice grinder). 484 g of polished rice was ground into a fine flour using a dry mill (spice grinder).

0.9 g of calcium chloride was dissolve in 6 litres of water at 35° C. 5 g of a bacterial derived (Bacillus Subtilis) food grade, α-amylase enzyme, as supplied by CYGYC BIOCON, S.L, and marketed under the brand name “BIALFA” was then added to the water. After which the, 1300 g of tiger nut flour, 216 g hazelnut flour and 484 g of rice flour were combined together, added to the water and blended for 4 minutes with a high shear mixer to form a slurry. pH measurements were recorded: the mixture was pH 6.

The mixture was then transferred to an electric heated cooker with agitator (as manufactured by savage bros, model: Firemixer-14), such that it could be continuously stirred and heated to optimum enzyme activation temperatures. The mixture was increased from its starting temperature of 35° C. by 2° C. per min to a temperature of 50° C. The mixture was then held at 50° C. for 7 minutes. The mixture was then increased in temperature by 2° C. per minute to 75° C. The mixture was then held at 75° C. for a period of 15 minutes. The mixture was then increased in temperature by 1° C. per minute to a temperature of 85° C. The mixture was then held at 85° C. for 10 minutes. The mixture was then increased in temperature by 2° C. per minute to 100° C. and then held at 100° C. for 2 minutes to denature the heat sensitive liquefaction enzyme. The mixture was then cooled to 50° C. and subsequently treated with 6 g of a fungal derived (Aspergillus oryzae) α-amylase in a saccharification step, as supplied by CYGYC BIOCON, S.L and which is marketed under the brand name ‘SUKZYME L’. The mixture was then increased in temperature by 2° C. per minute to 60° C. The mixture was then held at 60° C. for 30 minutes, after which the mixture was allowed to cool. Once cooled to below 40° C. the slurry was then strained using a 100 micron screen to separate oversized particles. Once strained, 1220 g of sugar (sucrose) was dissolved in plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PFC’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a laboratory scale z-blade mixer, manufactured by Winkworth, heated to 70° C. and gently mixed with 341 g of cocoa liquor for 5 minutes to produce a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 90° C. for another hour. The resulting crumb was removed from the oven, with a total moisture content of approximately 2%.

A total weight of approximately 2500 g of the crumb was allowed to cool, broken up with a hammer, and stored in air tight containers until such time that it was needed. At which point it is transferred to mill and reduced to a powder with a particle size of less than 200 microns.

The vegan crumb powder was subsequently mixed with 633 g of cocoa butter, 16.6 g of sunflower lecithin and 13 g of flavouring, and subjected to a process of refining, conching, tempering, depositing and cooling as per conventional milk chocolate production, to produce approximately 3150 g of a dairy-free alternative to milk chocolate.

### Example 2

A vegan crumb, for use in the production of a dairy-free alternative to milk chocolate was prepared in the following way.

20 kg (dry weight) of cleaned, polished tiger nuts were partially defatted, if required, to a fat content of around 12% with the use of a preheated oil screw press.

10 kg (dry weight) of polished rice was ground into coarse flour using a dry mill.

5 kg (dry weight) of raw hazelnuts were roasted at 142° C. for 50 min, then cooled and ground into a coarse flour using a dry mill.

3.9 kg of the (optionally partially defatted) Tiger nut flour, 1.571 kg of the rice flour and 0.648 kg of the roasted hazelnut flour were weighed out (dry weight), and added to 20.22 liters of warm water (30° C.) treated with 3 g of calcium chloride, and blended for 5 minutes with a high shear mixer to form a slurry. The slurry was then strained using a 100 micron screen to yield approximately 19.5 kg of plant-based milk, with a total solids content of approximately 17.337%.

The pH of the plant-based milk was adjusted to pH of 6 and transferred to a jacketed cooker for example such as is manufactured by Otto Hansel (HWR cooker) with integrated agitator and vacuum pump. The plant-based milk was then treated with a bacterial derived (Bacillus Subtilis) food grade, α-amylase enzyme in a liquefaction step, as supplied by CYGYC BIOCON, S.L, which is marketed under the brand name “BIALFA”. The plant-based milk was then stirred and heated for 20 minutes at 50° C. with BIALFA at 0.25% of the original flour weight, and then subsequently stirred and heated to 85° C. for 25 minutes.

The plant-based milk was allowed to cool to 60° C. and subsequently treated with a fungal derived (Aspergillus oryzae) α-amylase in a saccharification step, as supplied by CYGYC BIOCON, S.L and which is marketed under the brand name ‘SUKZYME L’, and was stirred and heated for 30 minutes at 60° C. with SUKZYME L. at 0.3% of the original flour weight.

Whilst held at 60° C. the plant-based milk was then sweetened with 3.64 kg of sucrose and stirred until all sucrose was dissolved. The resulting sweetened plant-based milk was treated with a silicon based anti-foam agent (as supplied by Murphy & Son and marketed under the brand name ‘ANTIFOAM FD20PK’) and concentrated through a process of evaporation under a reduced atmospheric pressure of 400 millibars, whilst being stirred continuously, the plant-based milk was heated and brought to a boil. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a z-blade mixer, manufactured by Winkworth, heated to 70° C. and gently mixed with 1.044 kg of cocoa liquor for 5 minutes to produce a thick paste. The paste was loaded into 4 trays at a thickness of approximately 2 cm, and transferred to a vacuum oven with heated shelves, as manufactured by Memmert GmbH+Co. KG, complete with vacuum pumps.

The atmospheric pressure in the ovens was reduced to 50 millibar, and the oven shelves were heated to 80° C. for 1 hour, after which the atmospheric pressure was reduced to 25 millibar and the temperature of the shelves increased to 90° C. for another hour. The resulting crumb was removed from the oven, with a total moisture content of approximately 2%. A total weight of approximately 7.88 kg of the crumb was allowed to cool, broken up with a hammer, and stored in air tight containers until such time that it was needed. At which point it is transferred to mill and reduced to a powder with a particle size of less than 200 microns.

The vegan crumb powder was subsequently mixed with 1.9 kg of cocoa butter, 0.05 kg of sunflower lecithin and 0.04 kg of flavouring, and subjected to a process of refining, conching, tempering, depositing and cooling as per conventional milk chocolate production, to produce approximately 9.87 kg of a dairy-free alternative to milk chocolate.

### Example 3

A vegan crumb, for use in the production of a dairy-free alternative to milk chocolate was prepared in the following way.

10 kg (dry weight) of polished rice was ground into coarse flour using a dry mill.

5 kg (dry weight) of raw hazelnuts were roasted at 142° C. for 50 min, then cooled and ground into a coarse flour using a dry mill.

3.9 kg of commercially sourced (optionally partially defatted to a fat content of around 12%) Tiger nut flour, 1.571 kg of the rice flour and 0.648 kg of the roasted hazelnut flour were weighed out (dry weight), and added to 20.22 liters of warm water (30° C.) treated with 3 g of calcium chloride and blended for 5 minutes with a high shear mixer to form a slurry. The slurry was then strained using a 100 micron screen to yield approximately 19.5 kg of plant-based milk, with a total solids content of approximately 17.337%.

The pH of the plant-based milk was adjusted to pH of 6 and transferred to a jacketed cooker for example such as is manufactured by Otto Hansel (HWR cooker) with integrated agitator and vacuum pump. The milky-wort was then treated with a bacterial derived (Bacillus Subtilis) food grade, α-amylase enzyme in a liquefaction step, as supplied by CYGYC BIOCON, S.L, which is marketed under the brand name “BIALFA”. The plant-based milk was then stirred and heated for 20 minutes at 50° C. with BIALFA at 0.25% of the original flour weight, and then subsequently stirred and heated to 85° C. for 25 minutes.

The plant-based milk was allowed to cool to 60° C. and subsequently treated with a fungal derived (Aspergillus oryzae) α-amylase in a saccharification step, as supplied by CYGYC BIOCON, S.L and which is marketed under the brand name ‘SUKZYME L’, and was stirred and heated for 30 minutes at 60° C. with SUKZYME L at 0.3% of the original flour weight.

Whilst held at 60° C. the plant-based milk was then sweetened with 3.64 kg of sucrose and stirred until all sucrose was dissolved. The resulting sweetened plant-based milk was treated with a silicon based anti-foam agent (as supplied by Murphy & Son and marketed under the brand name ‘ANTIFOAM FD20PK’) and concentrated through a process of evaporation under a reduced atmospheric pressure of 400 millibars, whilst being stirred continuously, the plant-based milk was heated and brought to a boil. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a z-blade mixer, manufactured by Winkworth, heated to 70° C. and gently mixed with 1.044 kg of cocoa liquor for 5 minutes to produce a thick paste. The paste was loaded into 4 trays at a thickness of approximately 2 cm, and transferred to a vacuum oven with heated shelves, as manufactured by Memmert GmbH+Co. KG, complete with vacuum pumps.

The atmospheric pressure in the ovens was reduced to 50 millibar, and the oven shelves were heated to 80° C. for 1 hour, after which the atmospheric pressure was reduced to 25 millibar and the temperature of the shelves increased to 90° C. for another hour. The resulting crumb was removed from the oven, with a total moisture content of approximately 2%. A total weight of approximately 7.88 kg of the crumb was allowed to cool, broken up with a hammer, and stored in air tight containers until such time that it was needed. At which point it is transferred to mill and reduced to a powder with a particle size of less than 200 microns.

The vegan crumb powder was subsequently mixed with 1.9 kg of cocoa butter, 0.05 kg of sunflower lecithin and 0.04 kg of flavouring, and subjected to a process of refining, conching, tempering, depositing and cooling as per conventional milk chocolate production, to produce approximately 9.87 kg of a dairy-free alternative to milk chocolate.

### Example 4

The following examples outlines a method for producing a white vegan crumb, for use in the production of a dairy-free alternative to white chocolate.

1000 g of polished rice was ground into a fine flour using a dry mill (spice grinder). 350 g of raw hazelnuts were placed on a tray and roasted in an oven at 140° C. for 20 min, then cooled and ground into a fine flour using a dry mill (spice grinder). 650 g of whole tiger nut was ground into a fine flour using a dry mill (spice grinder).

0.9 g of calcium chloride was dissolve in 6 litres of water at 35° C. 5 g of a bacterial derived (Bacillus Subtilis) food grade, α-amylase enzyme, as supplied by CYGYC BIOCON, S.L, and marketed under the brand name “BIALFA” was then added to the water. After which the 1000 g of rice flour, 350 g of roasted hazelnut flour and 650 g of Tiger nut flour were combined together, added to the water and blended for 4 minutes with a high shear mixer to form a slurry. pH measurements were recorded, the mixture was pH 6.06.

The mixture was then transferred to an electric heated cooker with agitator (as manufactured by savage bros, model: Firemixer-14), such that it could be continuously stirred and heated to optimum enzyme activation temperatures. The mixture was increased from its starting temperature of 35° C. by 2° C. per min to a temperature of 50° C. The mixture was then held at 50° C. for 7 minutes. The mixture was then increased in temperature by 2° C. per minute to 75° C. The mixture was then held at 75° C. for a period of 15 minutes. The mixture was then increased in temperature by 1° C. per minute to a temperature of 85° C. The mixture was then held at 85° C. for 10 minutes. The mixture was then increased in temperature by 2° C. per minute to 100° C. and then held at 100° C. for 2 minutes to denature the heat sensitive liquefaction enzyme. The mixture was then cooled to 50° C. and subsequently treated with 6 g of a fungal derived (Aspergillus oryzae) α-amylase in a saccharification step, as supplied by CYGYC BIOCON, S.L and which is marketed under the brand name “SUKZYME L”. The mixture was then increased in temperature by 2° C. per minute to 60° C. The mixture was then held at 60° C. for 30 minutes, after which the mixture was allowed to cool. Once cooled to below 40° C. the slurry was then strained using a 100 micron screen to separate oversized particles. Once strained, 1000 g of sugar (sucrose) was dissolved in plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PK’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 90%.

The sweetened condensed plant-based milk was discharged into a laboratory scale z-blade mixer, manufactured by Winkworth, heated to 70° C. and gently mixed to a thick paste for 5 minutes to improve the crystallization process. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 90° C. for another hour. The resulting crumb was removed from the oven, with a total moisture content of less than 2%. A total weight of approximately 2070 g of the crumb was allowed to cool, broken up with a hammer, and stored in air tight containers until such time that it was needed. At which point it is transferred to mill and reduced to a powder with a particle size of less than 200 microns.

The vegan crumb powder was subsequently mixed with 1000 g of cocoa butter, 18.5 g of sunflower lecithin and 18 g of flavouring, and subjected to a process of refining, conching, tempering, depositing and cooling as per conventional milk chocolate production, to produce approximately 2810 g of a dairy-free alternative to white chocolate.

### Example 5

The following example outlines a method for producing a white vegan crumb, for use in the production of a dairy-free alternative to white chocolate.

A vegan crumb, for use in the production of dairy-free alternative to white chocolate was prepared in the following way.

20 kg (dry weight) of cleaned, polished tiger nuts were partially defatted, if needed, to a fat content of about 12% with the use of a preheated oil screw press.

10 kg (dry weight) of polished rice was ground into course flour using a dry mill.

5 kg (dry weight) of raw hazelnuts were roasted at 142° C. for 50 min, then cooled and ground into a course flour using a dry mill.

3.9 kg of the (optionally partial defatted) Tiger nut flour, 1.571 kg of the rice flour and 0.648 kg of the roasted hazelnut flour were weighed out (dry weight), and added to 20.22 liters of warm water (30° C.) treated with 3 g of calcium chloride, and blended for 5 minutes with a high shear mixer to form a slurry. The slurry was then strained using a 100 micron screen to yield approximately 19.5 kg of plant-based milk, with a total solids content of approximately 17.337%.

The pH of the plant-based milk was adjusted to pH of 6 and transferred to a jacketed cooker manufactured by Otto Hansel (HWR cooker) with integrated agitator and vacuum pump. The milky-wort was then treated with a bacterial derived (Bacillus Subtilis) food grade, α-amylase enzyme in a liquefaction step, as supplied by CYGYC BIOCON, S.L, which is marketed under the brand name “BIALFA”. The plant-based milk was then stirred and heated for 20 minutes at 50° C. with BIALFA at 0.25% of the original flour weight, and then subsequently stirred and heated to 85° C. for 25 minutes.

The plant-based milk was allowed to cool to 60° C. and subsequently treated with a fungal derived (Aspergillus oryzae) α-amylase in a saccharification step, as supplied by CYGYC BIOCON, S.L and which is marketed under the brand name “SUKZYME L”, and was stirred and heated for 30 minutes at 60° C. with SUKZYME L at 0.3% of the original flour weight.

Whilst held at 60° C. the plant-based milk was then sweetened with 3.64 kg of sucrose and stirred until all sucrose was dissolved. The resulting sweetened plant-based milk was treated with a silicon based anti-foam agent (as supplied by Murphy & Son and marketed under the brand name ‘ANTIFOAM FD20PK’) and concentrated through a process of evaporation under a reduced atmospheric pressure of 400 millibars, whilst being stirred continuously, the plant-based milk was heated and brought to a boil. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a z-blade mixer, manufactured by Winkworth, heated to 70° C. under a reduced atmospheric pressure of 50 millibar during the mixing process to concentrate the paste further and accelerate crystallisation and thickening of the paste.

Once the paste reached a total solids content of 90%, the paste was loaded into 4 trays at a thickness of approximately 2 cm, and transferred to a vacuum oven with heated shelves, as manufactured by Memmert GmbH+Co. KG, complete with vacuum pumps.

The atmospheric pressure in the ovens was reduced to 50 millibar, and the oven shelves were heated to 80° C. for 1 hour, after which the atmospheric pressure was reduced to 25 millibar and the temperature of the shelves increased to 90° C. for another hour. The resulting vegan crumb was removed from the oven, with a total moisture content of approximately 2%. A total weight of approximately 6.82 kg of the vegan crumb was allowed to cool, broken up with a hammer, then transferred to mill and reduced to a powder with a particle size of 200 microns and stored in air tight containers until such time that it was needed.

The vegan crumb powder was subsequently mixed with 3.4 kg of cocoa butter, 0.047 kg of sunflower lecithin and 0.037 kg of flavouring, and subjected to a process of refining, conching, tempering, depositing and cooling as per conventional white chocolate production, to produce approximately 9.3 kg of a dairy-free alternative to white chocolate.

### Example 6

The following example outlines a method for producing a white vegan crumb, for use in the production of a dairy-free alternative to white chocolate.

A vegan crumb, for use in the production of dairy-free alternative to white chocolate was prepared in the following way.

10 kg (dry weight) of polished rice was ground into course flour using a dry mill.

5 kg (dry weight) of raw hazelnuts were roasted at 142° C. for 50 min, then cooled and ground into a course flour using a dry mill.

3.9 kg of commercially sourced (optionally partial defatted to a fat content of about 12%) Tiger nut flour, 1.571 kg of the rice flour and 0.648 kg of the roasted hazelnut flour were weighed out (dry weight), and added to 20.22 liters of warm water (30° C.), treated with 3 g of calcium chloride and blended for 5 minutes with a high shear mixer to form a slurry. The slurry was then strained using a 100 micron screen to yield approximately 19.5 kg of plant-based milk, with a total solids content of approximately 17.337%.

The pH of the plant-based milk was adjusted to pH of 6 and transferred to a jacketed cooker manufactured by Otto Hansel (HWR cooker) with integrated agitator and vacuum pump. The milky-wort was then treated with a bacterial derived (Bacillus Subtilis) food grade, α-amylase enzyme in a liquefaction step, as supplied by CYGYC BIOCON, S.L, which is marketed under the brand name “BIALFA”. The plant-based milk was then stirred and heated for 20 minutes at 50° C. with BIALFA at 0.25% of the original flour weight, and then subsequently stirred and heated to 85° C. for 25 minutes.

The plant-based milk was allowed to cool to 60° C. and subsequently treated with a fungal derived (Aspergillus oryzae) α-amylase in a saccharification step, as supplied by CYGYC BIOCON, S.L and which is marketed under the brand name ‘SUKZYME L’, and was stirred and heated for 30 minutes at 60° C. with SUKZYME L at 0.3% of the original flour weight.

Whilst held at 60° C. the plant-based milk was then sweetened with 3.64 kg of sucrose and stirred until all sucrose was dissolved. The resulting sweetened plant-based milk was treated with a silicon based anti-foam agent (as supplied by Murphy & Son and marketed under the brand name ‘ANTIFOAM FD20PK’) and concentrated through a process of evaporation under a reduced atmospheric pressure of 400 millibars, whilst being stirred continuously, the plant-based milk was heated and brought to a boil. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a z-blade mixer, manufactured by Winkworth, heated to 70° C. under a reduced atmospheric pressure of 50 millibar during the mixing process to concentrate the paste further and accelerate crystallisation and thickening of the paste.

Once the paste reached a total solids content of 90%, the paste was loaded into 4 trays at a thickness of approximately 2 cm, and transferred to a vacuum oven with heated shelves, as manufactured by Memmert GmbH+Co. KG, complete with vacuum pumps.

The atmospheric pressure in the ovens was reduced to 50 millibar, and the oven shelves were heated to 80° C. for 1 hour, after which the atmospheric pressure was reduced to 25 millibar and the temperature of the shelves increased to 90° C. for another hour. The resulting vegan crumb was removed from the oven, with a total moisture content of approximately 2%. A total weight of approximately 6.82 kg of the vegan crumb was allowed to cool, broken up with a hammer, then transferred to mill and reduced to a powder with a particle size of 200 microns and stored in air tight containers until such time that it was needed.

The vegan crumb powder was subsequently mixed with 3.4 kg of cocoa butter, 0.047 kg of sunflower lecithin and 0.037 kg of flavouring, and subjected to a process of refining, conching, tempering, depositing and cooling as per conventional white chocolate production, to produce approximately 9.3 kg of a dairy-free alternative to white chocolate.

### Example 7

The following example outlines a method for producing a vegan crumb, for use in the production of a dairy-free alternative to milk chocolate.

1000 g of polished rice was ground into a fine flour using a dry mill (spice grinder). 1000 g of rolled oats were ground into a fine powder using a dry mill (spice grinder).

0.9 g of calcium chloride was dissolve in 6 litres of water at 45° C. 5 g of a bacterial derived (Bacillus Subtilis) food grade, α-amylase enzyme, as supplied by CYGYC BIOCON, S.L, and marketed under the brand name “BIALFA” was then added to the water. 0.3 g of a food grade betaglucanase derived from a selected strain of Aspergillus, as supplied by CYGYC BIOCON, S.L, and marketed under the brand name BIOBETA P 100, was also added to the water. After which the 1000 g of rice flour and 1000 g of oat flour were combined together, added to the water and blended for 4 minutes with a high shear mixer to form a slurry. pH measurements were recorded, the mixture was pH 6.5. The pH of the mixture was subsequently then adjusted to pH 5.5.

The mixture was then transferred to an electric heated cooker with agitator (as manufactured by savage bros, model: Firemixer-14), such that it could be continuously stirred and heated to optimum enzyme activation temperatures. The mixture was increased from its starting temperature of 45° C. by 2° C. per min to a temperature of 50° C. The mixture was then held at 50° C. for 5 minutes. The mixture was then increased in temperature by 1° C. per minute to 55° C. The mixture was then held at 55° C. for a further 5 minutes. The mixture was then increased in temperature by 2° C. per minute to a temperature of 60° C. The mixture was then held at 60° C. for 10 minutes. The mixture was then increased in temperature by 1° C. per minute to 75° C. and then held at 75° C. for 10 minutes. The mixture was then increased in temperature by 2° C. per minute to a temperature of 85° C. and then held at 85° C. for 10 minutes. The mixture was then heat 1° C. per minute to a temperature of 100° C. and at that temperature for 2 minutes. There after the mixer was allowed to cool to 50° C. and subsequently treated with 6 g of a fungal derived (Aspergillus oryzae) α-amylase in a saccharification step, as supplied by CYGYC BIOCON, S.L and which is marketed under the brand name ‘SUKZYME L’. The mixture was then increased in temperature by 2° C. per minute to 60° C. The mixture was then held at 60° C. for 30 minutes, after which the mixture was allowed to cool. Once cooled to below 40° C. the slurry was then strained using a 100 micron screen to separate oversized particles.

Once strained, 1700 g of sugar (sucrose) was dissolved in the plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PK’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a laboratory scale z-blade mixer, manufactured by Winkworth, heated to 70° C. and gently mixed with 455 g of cocoa liquor and kneaded for 5 minutes to create a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 90° C. for another hour. The resulting crumb was removed from the oven, with a total moisture content of less than 2%. A total weight of approximately 3560 g of the crumb was allowed to cool, broken up with a hammer, and stored in air tight containers until such time that it was needed. At which point it is transferred to mill and reduced to a powder with a particle size of less than 200 microns.

The vegan crumb powder was subsequently mixed with 1300 g of cocoa butter, 25 g of sunflower lecithin and 20 g of flavouring, and subjected to a process of refining, conching, tempering, depositing and cooling as per conventional milk chocolate production, to produce approximately 4870 g of a dairy-free alternative to milk chocolate.

### Example 8

A vegan crumb, for use in the production of a dairy-free alternative to milk chocolate was prepared in the following way.

1000 g of rolled oats were mixed with 1000 g of a commercial bought (optionally partially defatted to a fat content of about 12%) tiger nut flour and together ground into a fine flour using a dry mill (spice grinder).

0.9 g of calcium chloride was dissolve in 6 litres of water at 45° C. 5 g of a bacterial derived (Bacillus Subtilis) food grade, α-amylase enzyme, as supplied by CYGYC BIOCON, S.L, and marketed under the brand name “BIALFA” was then added to the water. 0.3 g of a food grade betaglucanse derived from a selected strain of Aspergillus, as supplied by CYGYC BIOCON, S.L, and marketed under the brand name BIOBETA P 100, was also added to the water. After which the 1000 g of rolled oat flour and 1000 g of tiger nut flour were added to the water and blended for 4 minutes with a high shear mixer to form a slurry. pH measurements were recorded, the mixture was pH 6. The pH of the mixture was subsequently then adjusted to pH 5.5.

The mixture was then transferred to an electric heated cooker with agitator (as manufactured by savage bros, model: Firemixer-14), such that it could be continuously stirred and heated to optimum enzyme activation temperatures. The mixture was increased from its starting temperature of 45° C. by 2° C. per min to a temperature of 50° C. The mixture was then held at 50° C. for 5 minutes. The mixture was then increased in temperature by 1° C. per minute to 55° C. The mixture was then held at 55° C. for a further 5 minutes. The mixture was then increased in temperature by 2° C. per minute to a temperature of 60° C. The mixture was then held at 60° C. for 10 minutes. The mixture was then increased in temperature by 1° C. per minute to 75° C. and then held at 75° C. for 10 minutes. The mixture was then increased in temperature by 2° C. per minute to a temperature of 85° C. and then held at 85° C. for 10 minutes. The mixture was then heat 1° C. per minute to a temperature of 100° C. and at that temperature for 2 minutes. There after the mixer was allowed to cool to 50° C. and subsequently treated with 6 g of a fungal derived (Aspergillus oryzae) α-amylase in a saccharification step, as supplied by CYGYC BIOCON, S.L and which is marketed under the brand name ‘SUKZYME L’. The mixture was then increased in temperature by 2° C. per minute to 60° C. The mixture was then held at 60° C. for 30 minutes, after which the mixture was allowed to cool. Once cooled to below 40° C. the slurry was then strained using a 100 micron screen to separate oversized particles.

Once strained, 1600 g of sugar (sucrose) was dissolved in the plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PK’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a laboratory scale z-blade mixer, manufactured by Winkworth, heated to 70° C. and gently mixed with 400 g of cocoa liquor and kneaded for 5 minutes to create a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 90° C. for another hour. The resulting crumb was removed from the oven, with a total moisture content of less than 2%. A total weight of approximately 3120 g of the crumb was allowed to cool, broken up with a hammer, and stored in air tight containers until such time that it was needed. At which point it is transferred to mill and reduced to a powder with a particle size of less than 200 microns.

The vegan crumb powder was subsequently mixed with 1100 g of cocoa butter, 22 g of sunflower lecithin and 20 g of flavouring, and subjected to a process of refining, conching, tempering, depositing and cooling as per conventional milk chocolate production, to produce approximately 4250 g of a dairy-free alternative to milk chocolate.

### Example 9

A vegan crumb, for use in the production of a dairy-free alternative to milk chocolate was prepared using the following ingredients:

| Ingredients | Weight (g) | % |
|---|---|---|
| Peeled Raw Almonds | 1100 | 8.929% |
| (Variety: Marcona) | | |
| Polished White Rice | 1000 | 8.117% |
| Sugar (Sucrose) | 4000 | 32.468% |
| Cocoa Mass | 970 | 7.873% |
| Water | 5250 | 42.614% |
| Total | 12320 | 100% |

The process for the preparation of the crumb was as follows.

1000 g of polished rice and 1100 g of raw peeled almond (marcona) were ground into a fine flour using a dry mill (spice grinder). 0.79 g of calcium chloride was dissolve in 5.25 litres of water at 35° C. 5 g of a bacterial derived (Bacillus Subtilis) food grade, α-amylase enzyme, as supplied by CYGYC BIOCON, S.L, and marketed under the brand name “BIALFA” was then added to the water. After which all of the rice and almond flour were combined together, added to the water and blended for 4 minutes with a high shear mixer to form a slurry. pH measurements were recorded: the mixture was pH 6.1.

The mixture was then transferred to an electric heated cooker with agitator (as manufactured by savage bros, model: Firemixer-14), such that it could be continuously stirred and heated to optimum enzyme activation temperatures. The mixture was increased from its starting temperature of 35° C. by 2° C. per min to a temperature of 50° C. The mixture was then held at 50° C. for 7 minutes. The mixture was then increased in temperature by 2° C. per minute to 75° C. The mixture was then held at 75° C. for a period of 15 minutes. The mixture was then increased in temperature by 1° C. per minute to a temperature of 85° C. The mixture was then held at 85° C. for 10 minutes. The mixture was then increased in temperature by 2° C. per minute to 100° C. and then held at 100° C. for 2 minutes to denature the heat sensitive liquefaction enzyme. No saccharification step was performed. No separation step was performed.

4000 g of sugar (sucrose) was then dissolved in plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PK’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a laboratory scale z-blade mixer, manufactured by Winkworth, heated to 70° C. and gently mixed with 970 g of cocoa liquor for 5 minutes to produce a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 120° C. 45 minutes. The resulting crumb was removed from the oven, with a total moisture content of approximately 2% and a total weight of approximately 7194 g. The crumb was allowed to cool, broken up with a hammer, and stored in air tight containers until such time that it was needed.

Vegan milk chocolate was subsequently prepared using the following ingredients.

| Ingredients | Weight (g) | % |
|---|---|---|
| Crumb Powder | 6749.1 | 74.99% |
| Cocoa Butter (deoderised) | 2160 | 24% |
| Sunflower Lecithin | 54 | 0.6% |
| Dried Vanilla Pod Powder | 36.9 | 0.41% |
| Totals | 9000 g | 100% |

6749.1 g of the crumb was transferred to a mill and reduced to a powder with a particle size of less than 200 microns. The powder was then transferred to a stone melanger with 2160 g of melted cocoa butter, and 36.9 g of dried vanilla pod powder, where it was refined and conched at between 45-55 C, for a period of approximately 10 hours as per conventional milk chocolate production, prior to the mixing 54 g of sunflower lecithin to the liquid chocolate, then stored and allowed to cool.

### Example 10

A vegan crumb free from cereal grains and EU listed allergens, for use in the production of a dairy-free alternative to milk chocolate was prepared using the following ingredients:

| Ingredients | Weight (g) | % |
|---|---|---|
| Tiger nuts | 2500 | 20.004% |
| Water | 7500 | 60.012% |
| Hemp Protein Isolate | 20 | 0.160% |
| Sugar | 2000 | 16.003% |
| Cocoa Mass | 477.5 | 3.821% |
| Total | 12,497.5 | 100% |

The process for the preparation of the crumb was as follows.

2500 g of whole tiger nut were washed in water and then soaked in cold water. The tiger nuts were removed from the water after a period of 12 hours, and the water was discarded.

1.13 g of calcium chloride was dissolve in 7.5 litres of water at 35° C. 6.25 g of a bacterial derived (Bacillus Subtilis) food grade, α-amylase enzyme, as supplied by CYGYC BIOCON, S.L, and marketed under the brand name “BIALFA” was then added to the water. The tiger nuts were then added to the water and blended for 4 minutes with a high shear mixer to form a slurry. pH measurements were recorded: the mixture had a pH of 6.06.

The mixture was then transferred to an electric heated cooker with agitator (as manufactured by savage bros, model: Firemixer-14), such that it could be continuously stirred and heated to optimum enzyme activation temperatures. The mixture was then increased from its starting temperature of 35° C. by 2° C. per min to a temperature of 50° C. The mixture was then held at 50° C. for 7 minutes. The mixture was then increased in temperature by 2° C. per minute to 75° C. The mixture was then held at 75° C. for a period of 15 minutes. The mixture was then increased in temperature by 1° C. per minute to a temperature of 85° C. The mixture was then held at 85° C. for 10 minutes. The mixture was then increased in temperature by 2° C. per minute to 100° C. and then held at 100° C. for 2 minutes to denature the heat sensitive liquefaction enzyme. Once cooled to below 40° C. the slurry was then strained using a 100 micron screen

to separate oversized particles. Once strained, 20 g of hemp protein isolates and 2000 g of sugar was then dissolved in plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PK’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a laboratory scale z-blade mixer, manufactured by Winkworth, heated to 70° C. and gently mixed with 477.5 g of cocoa liquor for 5 minutes to produce a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 120° C. for 45 minutes. The resulting crumb was removed from the oven, with a total moisture content of approximately 2% and a total weight of approximately 3520 g. The crumb was allowed to cool, broken up with a hammer, and stored in air tight containers until such time that it was needed.

Vegan milk chocolate was subsequently prepared using the following ingredients.

| Ingredients | Weight (g) | % |
|---|---|---|
| Crumb Powder | 3374.55 | 74.965% |
| Cocoa Butter (deoderised) | 1080.00 | 23.992% |
| Sunflower Lecithin | 27.00 | 0.600% |
| Dried Vanilla Pod Powder | 19.95 | 0.443% |
| Totals | 4501.5 | 100% |

3374.55 g of the crumb was transferred to a mill and reduced to a powder with a particle size of less than 200 microns. The powder was then transferred to a stone melanger with 10800 g of melted cocoa butter, and 19.95 g of dried vanilla pod powder, where it was refined and conched at between 45-55° C., for a period of approximately 10 hours as per conventional milk chocolate production, prior to the mixing 27 g of sunflower lecithin to the liquid chocolate, then stored and allowed to cool.

### Example 11

A vegan crumb, for use in the production of a dairy-free alternative to milk chocolate was prepared using the following ingredients:

| Ingredients | Weight (g) | % |
|---|---|---|
| Hydrolyzed Rice Flour | 200.00 | 5.650% |
| Sugar (Sucrose) | 1700.00 | 48.023% |
| Cocoa Mass | 440.00 | 12.429% |
| Cocoa butter | 100.00 | 2.825% |
| Rice Syrup Solids | 600.00 | 16.949% |
| Water | 500.00 | 14.124% |
| Totals | 3540.00 | 100% |

The process for the preparation of the crumb was as follows.

600 g of Rice Syrup Solids with a dextrose equivalent (DE) value of 24, is dry mixed with 200 g of Hydrolyzed Rice Flour and 1700 g of sugar. The powder mix was transferred to an electrically heated cooker with agitator (as manufactured by savage bros, model: Firemixer-14), and 500 g of cold water was added. The mixture was gently heated and continuously stirred and as the liquid was brought to a temperature of 100° C. The sweetened condensed plant-based milk was then discharged into a laboratory scale z-blade mixer, manufactured by Winkworth, allowed to cool to 70° C. and then gently mixed with 440 g of cocoa liquor and 100 g of cocoa butter for 10 minutes to produce a thick paste.

The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 120° C. for 45 minutes. The resulting crumb was removed from the oven, with a total moisture content of approximately 2% and a total weight of approximately 3075 g. The crumb was allowed to cool, broken up with a hammer, and stored in air tight containers until such time that it was needed.

Vegan milk chocolate was subsequently prepared using the following ingredients.

| Ingredients | Weight (g) | % |
|---|---|---|
| Crumb Powder | 2500.00 | 70.694% |
| Cocoa Butter (deodorized) | 1000.00 | 28.278% |
| Sunflower Lecithin | 21.82 | 0.617% |
| Dried Vanilla Pod Powder | 14.55 | 0.411% |
| Totals | 3536.37 | 100% |

2500 g of the crumb was transferred to a mill and reduced to a powder with a particle size of less than 200 microns. The powder was then transferred to a stone melanger with 1000 g of melted cocoa butter, and 14.55 g of dried vanilla pod powder, where it was refined and conched at between 45-55 C, for a period of approximately 10 hours as per conventional milk chocolate production, prior to the mixing of 21.82 g of sunflower lecithin to the liquid chocolate, then stored and allowed to cool.

### Example 12

A vegan crumb, for use in the production of a dairy-free alternative to milk chocolate was prepared using the following ingredients:

| Ingredients | Weight (g) | % |
|---|---|---|
| Peeled Raw Almonds | 1100 | 8.929% |
| (Variety: Marcona) | | |
| Polished White Rice | 1000 | 8.117% |
| Sugar (Sucrose) | 4000 | 32.468% |
| Cocoa Mass | 970 | 7.873% |
| Water | 5250 | 42.614% |
| Total | 12320 | 100% |

The process for the preparation of the crumb was as follows.

1000 g of polished rice and 1100 g of raw peeled almond (marcona) were ground into a fine flour using a dry mill (spice grinder). 0.79 g of calcium chloride was dissolve in 5.25 litres of water at 35° C., and subsequently treated with 6 g of a fungal derived (Aspergillus oryzae) α-amylase, as supplied by CYGYC BIOCON, S.L and which is marketed under the brand name ‘SUKZYME L’. After which all of the rice and almond flour were combined together, added to the water and blended for 4 minutes with a high shear mixer to form a slurry. pH measurements were recorded: the mixture was pH 6.1.

The mixture was then transferred to an electric heated cooker with agitator (as manufactured by savage bros, model: Firemixer-14), such that it could be continuously stirred and heated to optimum enzyme activation temperatures. The mixture was heated to 50° C. and then increased in temperature by 2° C. per minute to 60° C. The mixture was then held at 60° C. for 30 minutes, after which the mixture was allowed to cool to 35° C. and treated with 5 g of a bacterial derived (Bacillus Subtilis) food grade, α-amylase enzyme, as supplied by CYGYC BIOCON, S.L, and marketed under the brand name “BIALFA”.

The mixture was increased from its starting temperature of 35° C. by 2° C. per min to a temperature of 50° C. The mixture was then held at 50° C. for 7 minutes. The mixture was then increased in temperature by 2° C. per minute to 75° C. The mixture was then held at 75° C. for a period of 15 minutes. The mixture was then increased in temperature by 1° C. per minute to a temperature of 85° C. The mixture was then held at 85° C. for 10 minutes. The mixture was then increased in temperature by 2° C. per minute to 100° C. and then held at 100° C. for 2 minutes to denature the heat sensitive liquefaction enzyme. No separation step was performed.

4000 g of sugar (sucrose) was then dissolved in plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PK’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a laboratory scale z-blade mixer, manufactured by Winkworth, heated to 70° C. and gently mixed with 970 g of cocoa liquor for 5 minutes to produce a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 120° C. for 45 minutes. The resulting crumb was removed from the oven, with a total moisture content of approximately 2% and a total weight of approximately 7194 g. The crumb was allowed to cool, broken up with a hammer, and stored in air tight containers until such time that it was needed.

Vegan milk chocolate was subsequently prepared using the following ingredients.

| Ingredients | Weight (g) | % |
|---|---|---|
| Crumb Powder | 6749.1 | 74.99% |
| Cocoa Butter (deoderised) | 2160 | 24% |
| Sunflower Lecithin | 54 | 0.6% |
| Dried Vanilla Pod Powder | 36.9 | 0.41% |
| Totals | 9000 g | 100% |

6749.1 g of the crumb was transferred to a mill and reduced to a powder with a particle size of less than 200 microns. The powder was then transferred to a stone melanger with 2160 g of melted cocoa butter, and 36.9 g of dried vanilla pod powder, where it was refined and conched at between 45-55 C, for a period of approximately 10 hours as per conventional milk chocolate production, prior to the mixing 54 g of sunflower lecithin to the liquid chocolate, then stored and allowed to cool.

### Example 13

A vegan crumb free from cereal grains and EU listed allergens, for use in the production of a dairy-free alternative to milk chocolate was prepared using the following ingredients:

| Ingredients | Weight (g) | % |
|---|---|---|
| Tiger nuts | 2500 | 20.004% |
| Water | 7500 | 60.012% |
| Hemp Protein Isolate | 20 | 0.160% |
| Sugar | 2000 | 16.003% |
| Cocoa Mass | 477.5 | 3.821% |
| Total | 12,497.5 | 100% |

The process for the preparation of the crumb was as follows.

2500 g of whole tiger nut were washed in water and then soaked in cold water. The tiger nuts were removed from the water after a period of 12 hours, and the water was discarded.

1.13 g of calcium chloride was dissolve in 7.5 litres of water at 35° C. and subsequently treated with 7.5 g of a fungal derived (Aspergillus oryzae) α-amylase, as supplied by CYGYC BIOCON, S.L and which is marketed under the brand name ‘SUKZYME L’. The pre-soaked tiger nuts were then added to the water and blended for 4 minutes with a high shear mixer to form a slurry. pH measurements were recorded: the mixture had a pH of 6.03.

The mixture was then transferred to an electric heated cooker with agitator (as manufactured by savage bros, model: Firemixer-14), such that it could be continuously stirred and heated to optimum enzyme activation temperatures. The mixture was heated to 50° C. and then increased in temperature by 2° C. per minute to 60° C. The mixture was then held at 60° C. for 30 minutes, after which the mixture was allowed to cool to 35° C. and treated with 6.25 g of a bacterial derived (Bacillus Subtilis) food grade, α-amylase enzyme, as supplied by CYGYC BIOCON, S.L, and marketed under the brand name “BIALFA” was then added to the water. The mixture was then increased from its starting temperature of 35° C. by 2° C. per min to a temperature of 50° C. The mixture was then held at 50° C. for 7 minutes. The mixture was then increased in temperature by 2° C. per minute to 75° C. The mixture was then held at 75° C. for a period of 15 minutes. The mixture was then increased in temperature by 1° C. per minute to a temperature of 85° C.

The mixture was then held at 85° C. for 10 minutes. The mixture was then increased in temperature by 2° C. per minute to 100° C. and then held at 100° C. for 2 minutes to denature the heat sensitive liquefaction enzyme. Once cooled to below 40° C. the slurry was then strained using a 100 micron screen to separate oversized particles. Once strained, 20 g of hemp protein isolate and 2000 g of sugar was then dissolved in plant-based milk and subsequently transferred to a steam jacketed toffee kettle, complete with agitator and vacuum pump (as manufactured by Wolff). The sweetened plant-based milk was treated with a silicon based anti-foam agent (as supplied by Murphy & Son and marketed under the brand name ‘ANTIFOAM FD20PFC’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 88%.

The sweetened condensed plant-based milk was discharged into a laboratory scale z-blade mixer, manufactured by Winkworth, heated to 70° C. and gently mixed with 477.5 g of cocoa liquor for 5 minutes to produce a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 120° C. for 45 minutes. The resulting crumb was removed from the oven, with a total moisture content of approximately 2% and a total weight of approximately 3520 g. The crumb was allowed to cool, broken up with a hammer, and stored in air tight containers until such time that it was needed.

Vegan milk chocolate was subsequently prepared using the following ingredients.

| Ingredients | Weight (g) | % |
|---|---|---|
| Crumb Powder | 3374.55 | 74.965% |
| Cocoa Butter (deoderised) | 1080.00 | 23.992% |
| Sunflower Lecithin | 27.00 | 0.600% |
| Dried Vanilla Pod Powder | 19.95 | 0.443% |
| Totals | 4501.5 | 100% |

3374.55 g of the crumb was transferred to a mill and reduced to a powder with a particle size of less than 200 microns. The powder was then transferred to a stone melanger with 1080 g of melted cocoa butter, and 19.95 g of dried vanilla pod powder, where it was refined and conched at between 45-55 C, for a period of approximately 10 hours as per conventional milk chocolate production, prior to the mixing 27 g of sunflower lecithin to the liquid chocolate, then stored and allowed to cool

### Example 14

A vegan crumb, for use in the production of a dairy-free alternative to white chocolate was prepared using the following ingredients:

| Ingredients | Weight (g) | % |
|---|---|---|
| Peeled Raw Almonds | 1100 | 9.524% |
| (Variety: Marcona) | | |
| Polished White Rice | 1000 | 8.658% |
| Cocoa Butter | 200 | 1.732 |
| Sugar (Sucrose) | 4000 | 34.632% |
| Water | 5250 | 45.454% |
| Total | 11550 | 100% |

The process for the preparation of the crumb was as follows.

1000 g of polished rice and 1100 g of raw peeled almond (marcona) were ground into a fine flour using a dry mill (spice grinder). 0.79 g of calcium chloride was dissolve in 5.25 litres of water at 35° C. 5 g of a bacterial derived (Bacillus Subtilis) food grade, α-amylase enzyme, as supplied by CYGYC BIOCON, S.L, and marketed under the brand name “BIALFA” was then added to the water. After which all of the rice and almond flour were combined together, added to the water and blended for 4 minutes with a high shear mixer to form a slurry. pH measurements were recorded: the mixture was pH 6.1.

The mixture was then transferred to an electric heated cooker with agitator (as manufactured by savage bros, model: Firemixer-14), such that it could be continuously stirred and heated to optimum enzyme activation temperatures. The mixture was increased from its starting temperature of 35° C. by 2° C. per min to a temperature of 50° C. The mixture was then held at 50° C. for 7 minutes. The mixture was then increased in temperature by 2° C. per minute to 75° C. The mixture was then held at 75° C. for a period of 15 minutes. The mixture was then increased in temperature by 1° C. per minute to a temperature of 85° C. The mixture was then held at 85° C. for 10 minutes. The mixture was then increased in temperature by 2° C. per minute to 100° C. and then held at 100° C. for 2 minutes to denature the heat sensitive liquefaction enzyme. No saccharification step was performed. No separation step was performed.

4000 g of sugar (sucrose) was then dissolved in plant-based milk and subsequently transferred to a steam jacketed toffee kettle, complete with agitator and vacuum pump (as manufactured by Wolff). The sweetened plant-based milk was treated with 200 g of cocoa butter and a silicon based anti-foam agent (as supplied by Murphy & Son and marketed under the brand name ‘ANTIFOAM FD20PK’, then concentrated through a process of heating under reduced atmospheric pressure. Steam supplied to the vessels jacket was maintained at 0.5 gauge pressure (BAR). Whilst being stirred continuously, the plant-based milk was heated and brought to a boil under a reduced atmospheric pressure of between 600 and 400 mbar. The low temperature boil was maintained by incrementally reducing the atmospheric pressure, to a final pressure of 100 mbar whilst continuing to heat and stir the product, until such time that the total solids content of the sweetened condensed plant-based milk reached approximately 90%.

The sweetened condensed plant-based milk was discharged into a laboratory scale z-blade mixer, manufactured by Winkworth, heated to 70° C. and gently mixed for 5 minutes to produce a thick paste. The paste was loaded into a tray at a thickness of approximately 2 cm, and transferred to a vacuum oven with heated shelves, as manufactured by Memmert GmbH+Co. KG, complete with vacuum pumps.

The atmospheric pressure in the ovens was reduced to 50 mbar, and the oven shelves were heated to 80° C. for 1 hour, after which the atmospheric pressure was reduced to 25 millibar and the temperature of the shelves increased to 120° C. 45 minutes. The resulting crumb was removed from the oven, with a total moisture content of approximately 2% and a total weight of approximately 6424 g. The crumb was allowed to cool, broken up with a hammer, and stored in air tight containers until such time that it was needed.

Vegan white chocolate was subsequently prepared using the following ingredients.

| Ingredients | Weight (g) | % |
|---|---|---|
| Crumb Powder | 6299.1 | 69.99% |
| Cocoa Butter (deoderised) | 2610 | 29% |
| Sunflower Lecithin | 54 | 0.6% |
| Dried Vanilla Pod Powder | 36.9 | 0.41% |
| Totals | 9000 g | 100% |

6299.1 g of the crumb was transferred to a mill and reduced to a powder with a particle size of less than 200 microns. The powder was then transferred to a stone melanger with 2610 g of melted cocoa butter, and 36.9 g of dried vanilla pod powder, where it was refined and conched at between 45-55 C, for a period of approximately 10 hours as per conventional white chocolate production, prior to the mixing 54 g of sunflower lecithin to the liquid chocolate, then stored and allowed to cool.

### Example 15

TABLE 1
Illustrates the carbohydrate and sugar profile for 100 g of rice
milk dry solids following different enzymatic treatment steps.

| | | | | | Of which | Of which | |
|---|---|---|---|---|---|---|---|
| | | | | | maltose | glucose | |
| | | Total | Of which | Of which | (reducing | (reducing | Of which |
| Treatment | Material | Carbs | starch | sugars | sugar) | sugar) | sucrose |
| a) Liquefaction | 100 g of | 97.34 | 9.73 | 13.48 | 6.14 | 7.45 | 0.00 |
| only | suspended | | | | | | |
| | rice solids | | | | | | |
| b) Saccharification | 100 g of | 96.03 | 6.68 | 19.71 | 10.75 | 8.97 | 0 |
| followed by | suspended | | | | | | |
| Liquefaction | rice solids | | | | | | |
| c) Liquefaction | 100 g of | 96.72 | 0 | 48.70 | 39.03 | 9.71 | 0 |
| followed by | suspended | | | | | | |
| Saccharification | rice solids | | | | | | |

### Example 16

A wide range of plant-based crumbs and plant-based chocolates can be prepared using the methods described herein, for example as exemplified above. Based on informal sensory testing, the following exemplary ranges for the nutritional profile can be determined. Without wishing to be bound by theory, crumbs and chocolates having compositions falling within the optimised ranges set out in Table 2 achieve a particularly good balance in terms of taste (sweetness and flavour complexity), mouthfeel, ease of production/processing, etc. That said, it will be appreciated that taste is a subjective measure and that different compositions/recipes/products may be suitable for different purposes.

TABLE 2

| | | | | | | REDUCING | | |
|---|---|---|---|---|---|---|---|---|
| | | | | | | SUGARS | | |
| | | | | | | (maltose & | | |
| | | | | TOTAL | TOTAL | glucose | | DIETARY |
| wt % | Moisture | Solids | FAT | CARBS | SUGARS | combined) | PROTEIN | FIBRE |
| VEGAN | 1-3% | 99-97% | 10-16% | 67-80% | 45-64% | 1.7-6.8% | 1.3-10.6% | 2.5-6.7% |
| CRUMB | | | | preferably | | | | |
| | | | | 73-76% | | | | |
| VEGAN | Less | Greater | 31-42% | 55-60% | 34-48% | 1.4-5.1% | 1-8% | 2-5% |
| CHOCOLATE | than 2% | than 98% | | | | | | |

1-45. (canceled)

46. A process for producing a crumb based on a plant-based milk, wherein said plant-based milk comprises an aqueous suspension of plant material, wherein the process comprises:
a liquefaction step, wherein polysaccharides in the plant material are liquefied by one or more enzymes;
and/or
a saccharification step, wherein reducing sugars are liberated from the plant material by one or more enzymes;
and crumb formation, wherein the plant-based milk is heated and dried to a crumb; wherein crumb formation comprises:
evaporation to form a condensed plant-based milk;
optionally, adding cocoa solids to the condensed plant-based milk; heating the condensed plant-based milk;
drying the condensed plant-based milk to a moisture content below about 5%, preferably to a moisture content of about 1-3%.

47. A process according to claim 46, wherein the crumb is allergen-free.

48. A process according to claim 46 wherein the plant-based milk comprises plant material from at least one nut, tuber, legume, or rice, preferably wherein the plant material is from tiger nut, sweet potato, rice, amaranth, teff, sorghum, quinoa, buckwheat, or combinations thereof,
and wherein the plant-based milk optionally further comprises an adjunct plant material selected from hazelnut, peanut, cashew nut, macadamia nut, coconut, almond, chickpea, pea, soya, hemp seed, sunflower seed, sesame seed and combinations thereof

49. A process according to claim 46, wherein the plant-based milk comprises plant material from tiger nut, rice or a combination thereof, or wherein the plant-based milk comprises plant material from tiger nut and sunflower seed.

50. A process according to claim 46, wherein the process further comprises addition of a sweetening composition to the plant-based milk, wherein the sweetening composition is added in an amount such that the total carbohydrate content of the final crumb is between about 30 and 85%, based on the total weight of the crumb

51. A process according to claim 50, wherein the sweetening composition comprises sucrose and wherein the sweetening composition is preferably added in an amount such that about 60-80% of the carbohydrate content in the final crumb consists of sugars.

52. A process according to claim 46, wherein evaporation is carried out at reduced pressure and at a temperature of at least about 60° C.

53. A process according to claim 46, further comprising addition of an anti-foaming agent prior to the evaporation step.

54. A process according to claim 46, wherein drying the condensed plant-based milk is carried out by heating the condensed plant-based milk to a temperature of about 80 to 150° C., preferably under vacuum.

55. A process according to claim 46, wherein the liquefaction enzyme is selected from an amylase, a glucanase, or a combination thereof; and/or wherein the saccharification enzyme comprises a fungal derived α-amylase or a β-amylase.

56. A process according to claim 46 wherein, after liquefaction and/or saccharification, the plant-based milk comprises from about 1% to about 50% reducing sugars, dry weight, wherein the reducing sugars comprise maltose.

57. A process according to claim 46, further comprising at least one protein adjustment step, wherein protein adjustment comprises:
a. protein hydrolysis, wherein the plant-based milk is treated with a proteolytic enzyme; or
b. addition of protein hydrolysates.

58. A process according to claim 57, wherein the proteolytic enzyme is selected from papain or a carboxypeptidase and/or wherein the protein hydrolysates are selected from soya, pea or hemp protein hydrolysates.

59. A process according to claim 46 wherein the process further comprises at least one defatting step, wherein the fat content of the plant-based milk is reduced to no more than 30% by weight on a dry weight basis.

60. A process according to claim 46 wherein the crumb has:
a fat content of about 5 to 16%, based on the total weight of the crumb;
a protein content of about 1 to 20%, based on the total weight of the crumb;
a carbohydrate content of about 67 to 80%, based on the total weight of the crumb;
and/or a total sugars content of about 40 to 64%, based on the total weight of the crumb.

61. A process according to claim 46, further comprising grinding the crumb to a particle size of less than 300 microns.

62. A process for producing a plant-based chocolate comprising:
a. producing a plant-based crumb by the process as defined in claim 46; and
b. mixing the crumb with a fat, wherein the fat is preferably selected from cocoa butter, cocoa butter substitute, cocoa butter replacer, cocoa butter extender and combinations thereof.

63. A process according to claim 62, wherein the chocolate has:
a total fat content of about 31 to 42%, based on the total weight of the chocolate;
a carbohydrate content of about 40 to 70%, based on the total weight of the chocolate; and/or
a total sugars content of about 34 to 48%, based on the total weight of the chocolate.

64. A plant-based product obtainable by a process according to claim 46.
